(19) United States
(12) Patent Application Publication
(10) Pub. No.: US 2006/0086799 A1
(43) Pub. Date: Apr. 27, 2006

(54) Email client and methods for commanding later re-delivery of messages

(75) Inventors: Michael L. Robertson, San Diego, CA (US); Kevin Carmony, San Diego, CA (US); Thomas C. Welch, San Diego, CA (US)

Correspondence Address: Everett D. Robinson;Parsons Behle & Latimer, 201 South Main Street, Suite 1800, Post Office Box 45898, Salt Lake City, UT, 84145-0898, US

(73) Assignee: Linspire, Inc.

(21) Appl. No.: 11/256,588

(22) Filed: Oct. 21, 2005

Related U.S. Application Data
(60) Provisional application No. 60/621,597, filed on Oct. 23, 2004.

(51) Int. Cl. G06K 7/10

(52) U.S. Cl. 235/462.1

(57) ABSTRACT

Disclosed herein are network systems that can retain pending forwarded messages for delivery at a specified time, and email clients functional to forward email messages to those servers with a delivery time and a list of recipient addresses and methods for operating those and similar systems. Also disclosed are network server systems that provide access to pending email messages to be forward to clients, permitting the listing, retrieval, searching and deletion of pending messages. Detailed information on various example embodiments of the inventions are provided in the Detailed Description below, and the inventions are defined by the appended claims.

### CROSS REFERENCE TO RELATED APPLICATIONS

This application claims the benefit of the U.S. Provisional Application No. 60/621,597 filed Oct. 23, 2004, which is hereby incorporated by reference in its entirety.

### REFERENCE TO COMPUTER PROGRAM LISTING APPENDIX

This application is submitted with a program listing on compact disc in accordance with 37 CFR 1.52. With this application is submitted two copies of a compact disc containing that program listing, for a total of two compact discs. The program listing and material contained on the compact disc are listed in Appendix I, below, which program listing and material are hereby incorporated by reference.

### BACKGROUND

The claimed inventions relate generally to network systems that can manage and forward email, and more particularly to servers that can retain pending forwarded messages for delivery at a specified time, email clients functional to forward email messages to those servers with a delivery time and a list of recipient addresses and methods for operating those and similar systems.

### BRIEF SUMMARY

Disclosed herein are network systems that can retain pending forwarded messages for delivery at a specified time, and email clients functional to forward email messages to those servers with a delivery time and a list of recipient addresses and methods for operating those and similar systems. Also disclosed are network server systems that provide access to pending email messages to be forward to clients, permitting the listing, retrieval, searching and deletion of pending messages. Detailed information on various example embodiments of the inventions are provided in the Detailed Description below, and the inventions are defined by the appended claims.

### BRIEF DESCRIPTION OF THE DRAWINGS

FIG. 1 conceptually shows a method of managing and forwarding email messages.

FIG. 2 shows a method of transacting email messages to be forwarded between an email client and a Mailminder server over an intermediate network.

FIG. 3 depicts an exemplary method of authentication through a subscribed service.

FIG. 4 conceptually shows an exemplary method of operating a Mailminder server.

FIG. 5 shows the main view of an exemplary email client operable with a Mailminder server.

FIG. 6 shows a configuration window of the exemplary email client.

FIG. 7 shows a window for managing lists of forwarding email addresses in the exemplary email client.

FIG. 8 depicts a message forwarding window of the exemplary email client.

FIG. 9 shows a minimized view of the window depicted in FIG. 8.

FIG. 10 shows a message retrieval window of the exemplary email client.

FIG. 11 shows a email presentation window of the exemplary email client.

Reference will now be made in detail to systems for storing and forwarding email messages at specified times, including Mailminder systems, which may include some more specific embodiments of the claimed inventions, examples of which are illustrated in the accompanying drawings.

### DETAILED DESCRIPTION

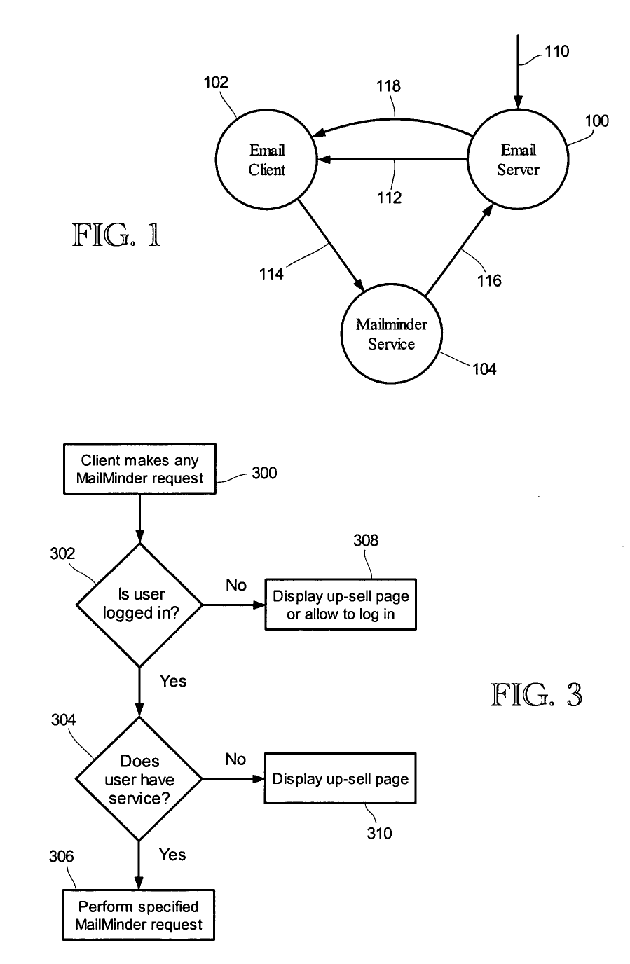

Referring first to FIG. 1, a method of managing emails is depicted. In an ordinary system of receiving email messages, an email server 100 is used. Email server 100 receives incoming email messages 110 from senders over a computer network. In a system of this type the Simple Mail Transport Protocol (SMTP) is ordinarily used, although another protocol could be used interchangeably. Upon receipt of an email message, email server stores the email message for retrieval by a user. Email servers such as 100 are usually employed where it is not desired to dedicate the resources of a client computer to waiting for and processing email. The reader will appreciate that an email server 100 might be employed as software on a client computer, or another computer, and no particular configuration is required.

Email client 102 in an ordinary email system is a software application running on a client computer, usually with local storage for retrieved email messages. At prescribed times, the email client 102 connects to the email server 100 to retrieve or download email messages 112 from server 100, which may be stored locally.

Now the reader may appreciate that the timing of arriving email messages is not under the control of the recipient, and those email messages may arrive at inconvenient times. For example, an email message might notify a user of a meeting he is to attend one week in the future. The user may face a decision from a number of undesirable choices. First, the user might delete the message and enter the meeting into a calendar, requiring an additional step in a potentially different tool, book or device. If the user is distracted or chooses to rely on his memory, he runs the risk of forgetting the event. Second, a user might leave the email message in his inbox. However if the user receives any significant number of messages between the arrival and the event, he may forget to look through his inbox and forget the event.

Other email messages are more than informative, demanding a response within a given time frame. For example, a manager might receive a message from her supervisor requesting status on a project at a meeting two days in the future. She might be engaged in a matter requiring her urgent attention, and may not be able to take the requested action immediately. Again, this user might leave the message in her mailbox for her later review, and if she remembers to look through past messages she may be reminded. However, if she receives too many messages her mailbox will become cluttered and it becomes more difficult to find the messages needing attention. Alternatively, she might move the email message to a different folder or mailbox reserved for important messages. But again, this method requires her to remember to look through that folder.

Now more recent email clients have integrated a calendar or a scheduling facility in an attempt to provide a single repository of user-related information, and some clients permit the scheduling of appointments between users. However these systems, to the present knowledge, do not utilize or benefit from the advantages of a separate service with the facilities for user controlled and scheduled forwarding described below.

Provided by systems described below are systems and methods of forwarding email messages for later delivery at a specified time. A user controlling email client 102 forwards 114 one or more email messages to a forwarding service 104 for storage. At the same time, the email message stored at the client may be deleted by the email client 102. Service 104 retains the email message until the scheduled delivery time, after which a reminder message is forwarded to the appropriate email server, which might be server 100 if the message was selected for delivery to the original recipient. A reminder message may include the entire original message or parts identifying the information of the original message, and may also include other details such as those described below. Delivery 116 may utilize a common mail transport protocol, such as SMTP, permitting the use of servers and clients that use non-proprietary protocols and eliminating the need for particular email servers and clients. Following delivery to email server 100, the forwarded reminder message may be delivered 118 to the email client 102 of the original recipient, if desired. For the remainder of the discussion below, a forwarding service such as that provided by service 104 operable to forward reminder email messages at a specified time will be referred to as a Mailminder or Mailminding service.

Also according to the inventive concepts, email client may be an application of various types executing on virtually any platform. In one example, the email client is the mail portion of a Mozilla browser running on a Linux platform, the delivery of email messages to a Mailminding service enabled by a plug-in application. In another example, the email client might be hard-coded with the operable routines and protocols to the particular Mailminding service. Virtually any email client might be enabled to utilize the Mailminding service if a user is enabled to select and forward email messages thereto. Furthermore, in the system of FIG. 1 virtually any email server type may be used. Indeed, through the use of a common mail transfer protocol the system may support multiple email server types, and thus this system may be used across various Internet service providers and/or email delivery networks.

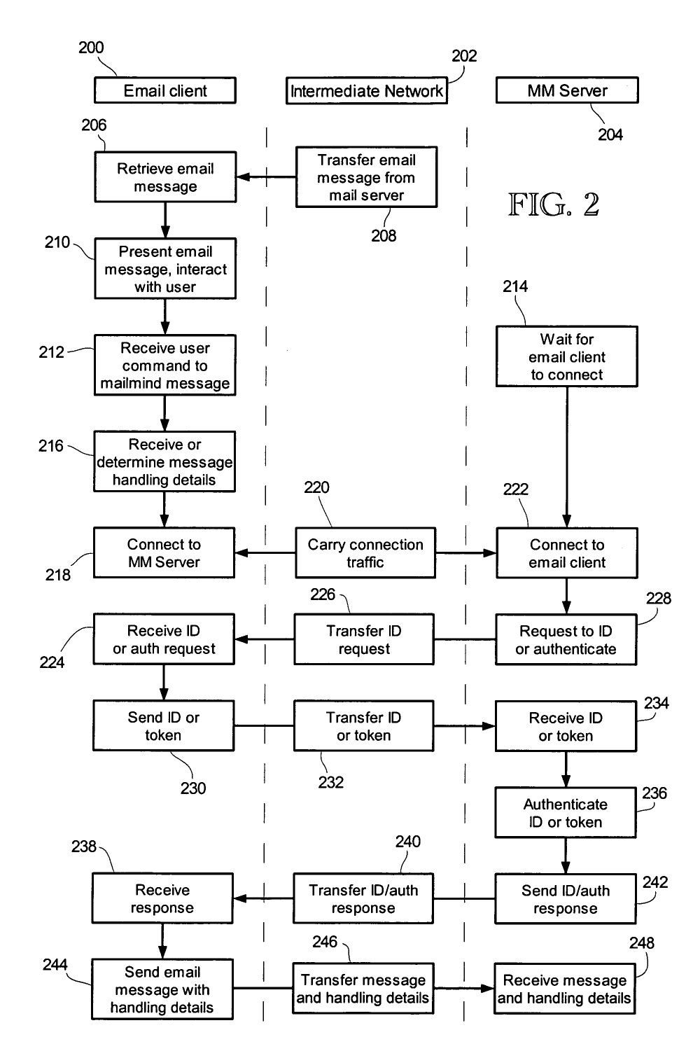

Shown now in FIG. 2 is a method of communication between an email client 202 and a Mailminder Server 204 over an intermediate network 202, such as the Internet, a wide area network, a local area network, or virtually any other network type. The method begins with the transfer of an email message 208 from a mail server over the intermediate network 202. Hereinafter and in the claims the carrying or transfer of any informational object means the delivery of those objects either from one network entity to another, across an entire intermediate network path or any portion of a network. The email client 200 retrieves the email message 206 and presents the email message to the user 210. The user may also be permitted interaction with the email message to delete, move or forward it or perform other actions if desired. A user may decide to manage the email message in Mailminded fashion. Email client 200 is configured to receive a user command 212 to Mailmind the message. Upon receipt of such a command, client 200 may also receive handling details for the message, for example a time of delivery and a list of addresses to forward the message to at the time of delivery.

Client 200, engaged in causing an email message to be Mailminded, connects to the Mailminder server 204. Mailminder server 204 when operational waits for email clients to make connections 214. Upon receiving a request 220 to connect across network 202, a connection to the client will generally be initiated 222. The connection between client 200 and server 204 might take any number of forms. For example, server 204 might be listening to an IP port, and may be configured to communicate with client 200 over a TCP connection. Alternatively, the connection might be made in a connectionless fashion, through the use of one-way messages and sufficient state to form a virtual connection, which might be done through the use of UDP packets or even email messages.

It may be desired to limit the use of Mailminder server 204 to authorized use. With that in mind, the method of FIG. 2 provides for authentication, although it is possible to operate a Mailminder service without authentication. Upon making a connection to a client, server 204 issues 228 a request for an identifier or a challenge to client 200, which is received by the client 224. The client responds with an identity or a token 230, transferred by the network 202 and received by the server 234. Alternatively, the client may spontaneously send an identifier to the server after connection, which might be done if the information is stored in a cookie and the connection uses an HTTP or HTTPS protocol. Even so, the reader will recognize that these exemplary methods of authentication may be departed from while maintaining a Mailminder service.

If authentication is used, the server may authenticate the received identity or token, for example by matching the identity in a table or database or by applying a public encryption key. A response is then formed for the client, which is sent thereto 242, carried over the network 240 and received by the client 238. The response might indicate the success or failure of authentication, or might reflect the state of server 204 as to capabilities, availability or other factors. Client 200, having recognized an enabled connection to server 204, may then send email messages 244 with the accompanying handling details. Now the handling details need not be sent in the same packet or even at the same time as the forwarded email message, provided that enough information is sent to server 204 to associate the handling details with the email messages. The email message and handling details are transferred across network 246 to server 204, which receives 248 and processes these accordingly.

Referring now to FIG. 3, an exemplary authentication scheme may take advantage of a user login to a subscribed service, which may be a more general service providing email and non-email services. For example, a subscription service might include a service and/or tool for downloading and installing software to a computer on which an email client is installed. In this example, the user logs into the service through the use of a web browser. When the login occurs, a cookie is placed in the cache store of the browser. As the user moves between pages of the subscription service, the cookie is sent to the server which can verify the user and/or session identity encoded within against a database of known subscribers. In this way, authentication can be performed by using a common authentication token and scheme operable across all the services provided by the subscription service. If a Mailminder service is included in the subscribed service, the service authentication scheme may be utilized to prevent unauthorized access to the Mailminder server.

The exemplary authentication scheme makes use of a daemon or other entity to listen for requests from clients. When a client makes a request to the Mailminder service 300, the request is accompanied by an authorizing cookie. The server can check the information of the cookie against a list or database of users presently logged in or for which sessions are known to be current, as in step 302. Now it is contemplated in the exemplary service that the Mailminder service might be made an additional service to the subscribed service. The exemplary method checks in step 304 if the user is subscribed to the Mailminder service, by identifying the user from the information sent in the cookie. If the check is positive, the Mailminder request is allowed 306. If the method determines that the request originates from a session of a logged-on user, but not from a user subscribed to the Mailminder service, the method displays a screen informing the user of the availability of the service 310, and optionally information suitable to subscribe the user. If the user cannot be verified to be logged on, the method displays a screen informing of the benefits of a subscription 308, and fields to enter login information should the user have merely forgotten to log on.

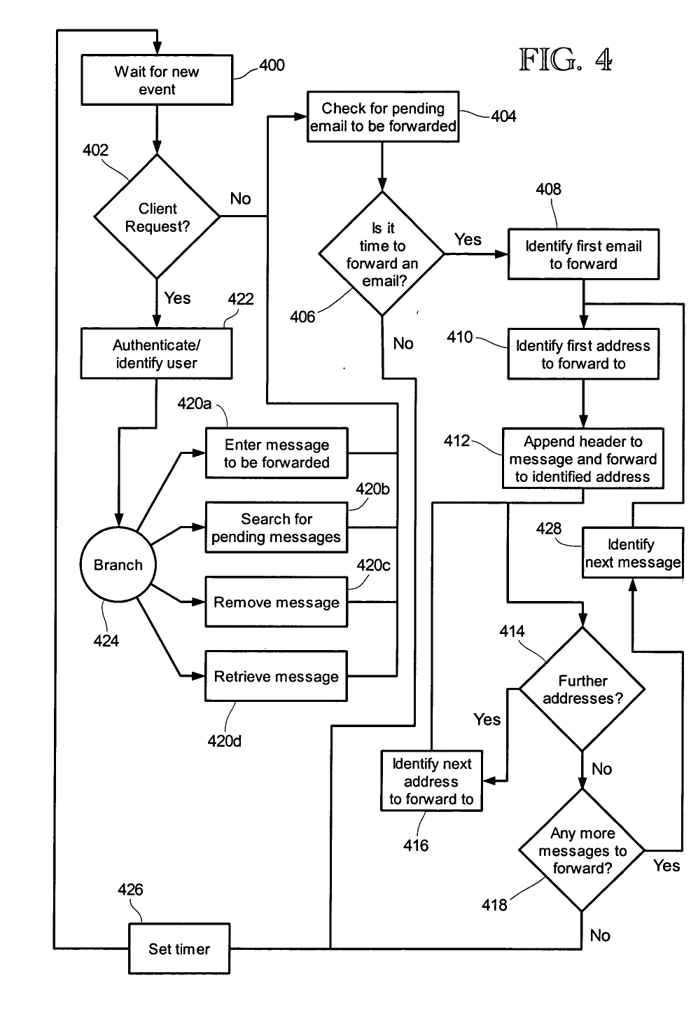

Now turning to FIG. 4, one exemplary Mailminder operational method is illustrated. That operation is generally divided into two main functions, which are processing client requests and forwarding deposited emails. The operation begins by with the reception or notification of a new event 400, which event might be a request to connect from client, an alarm, an execution of a script by a cron entry, or other event. If other events are received, they may be handled by steps not shown.

First, the exemplary operation determines whether the event is a client request 402. If not, the event is deemed to be a timer event. For a timer event, a check 404 is first undertaken to identify whether an email message is ready to be forwarded. In the exemplary operation an email message is ready if the present time is equal to or later than the time of delivery specified for the email message. This check may be performed, for example, by an examination of the stored email handling details for a time before the present time. If no email is found needing to be forwarded on this pass 406, the method sets a new timer 426 and loops back. Otherwise, the system identifies a first email message to forward 408. For each forwarded message, a first destination address is identified 410. For each address, a new reminder email is constructed with the destination address and the original email message with a header appended at the front or top 412. For example, the header might include text indicating the message was forwarded from the Mailminder server, the time and/or date it was forwarded therefrom, and the date/time that the email was originally sent or received. This header information may be located elsewhere in or with the email as desired.

The handling details for the identified message might specify more than one forwarding address. The operation checks for further addresses 414, identifies a next destination address 416 and repeats to forward the email message to the additional addresses 412. There may be more than one email to forward at any given time. The exemplary operation checks for further email messages to forward 418, and if there are any the next message is identified 428 and the operation repeats. When no further messages are left, a new timer is set 426 for the next interval.

If the event received is found to be a client request in step 402, an authentication step 422 may be performed. Following a positive authentication, the method may identify the request 424 according to type, which in this example are a request to enter a message to be forwarded 420a, a search for pending messages 402b, a request to remove a pending message 420c or a request to retrieve a pending message 420d. Following processing of a request, the operation may check for pending email forwarding events should the request processing run over a timer event.

Now it is to be understood that the operation of FIG. 4 is merely one example, shown sequentially for conceptual understanding. Another operation could utilize two processes running in parallel, one processing requests and the other timer events. Another operation might utilize threads, one for each event. The operation shown may therefore be modified in many ways to achieve a Mailminding system, as taught above and below.

Exemplary Email Client Implementation

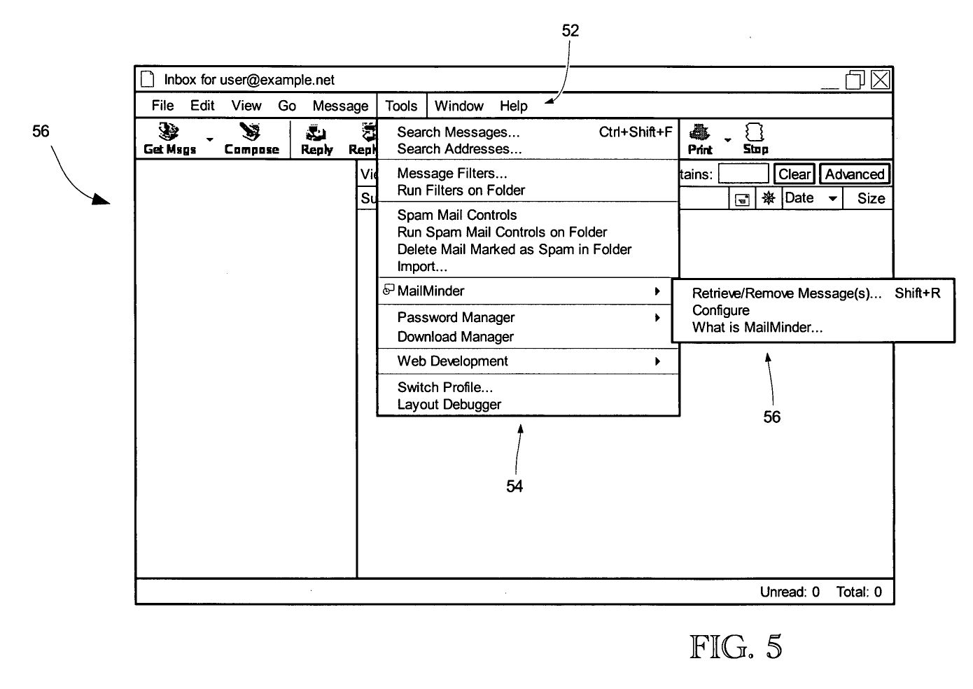

As suggested above, control of messages in a Mailminded system may be through an email client program. FIGS. 5 to 11 and succeeding figures depict one such email client in various states. Referring first to FIG. 5, the exemplary email client is based on a Mozilla platform, as that platform is conveniently configured to accept plug-in applications to extend additional functions and controls. Other email client platforms may be equally used, whether graphical, textual, monolithic or extendable through any number of possible architectures. In the exemplary client, a main view 50 includes a menu bar 52, wherein a hierarchical menu is accessible. In the exemplary menu configuration, Mailminder functions are available through the Tools->MailMinder menu panes 54 and 56, which as shown are to retrieve/remove messages, configure the service, and to provide information about the present Mailminder service.

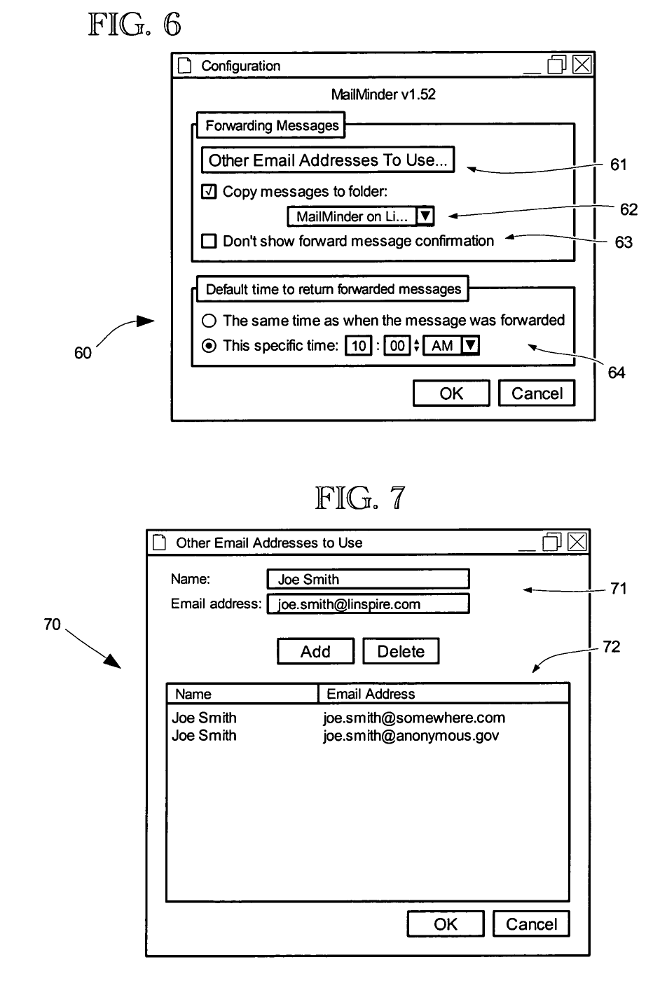

Selection of configuration from the menu opens a window 60 as depicted in FIG. 6. In the exemplary client program, a list of email address to forward to may be entered by selecting button object 61, which brings up a further window as described for FIG. 7. The client program is also functional to copy messages forwarded to a Mailminder server to a folder, providing access of the messages to the user without using server access functions described below. That may be done by enabling the checkbox and selecting an existing folder from list 62. The client program may also present a confirmation to the user when a message is successfully stored on a Mailminder server by checking checkbox 63.

The exemplary email client also maintains a default forwarding time, specifiable by objects 64. In this example, the user may specify a fixed default forwarding time, or forwarding of Mailminded email messages at the same time as the message was sent to the Mailminder server. The default time is entered for the user in a subsequent screen, described below, when a user commands an email message to be forwarded to the Mailminder service.

Shown in FIG. 7 is a window for the entry of lists of forwarding email addresses in the email client configuration. Principally, the list is useful where the user maintains several email boxes at different addresses, and desires to receive notification of Mailminded messages even if he is not able to access a default mailbox. Email addresses are entered in the text entry boxes 71, which appear in the list 72 by clicking on the ‘add’ button. Addresses may likewise be removed by selecting them in the list 72 and pressing the ‘delete’ button.

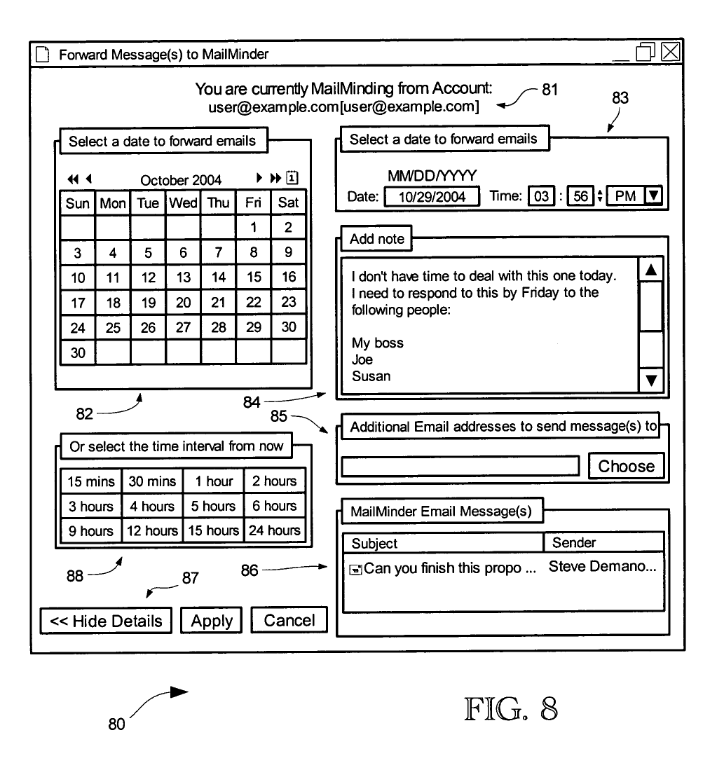

In the exemplary email client, a user may view email messages in one or more inboxes and folders. When it is desired to forward a message to the Mailminder service, the user selects the email message in a list and performs an action, such as pressing shift-M, selecting “forward to Mailminder” from the Message portion of the Menu or right-clicking on a message and selecting a “forward to Mailminder” option. Doing so opens a window in the exemplary client as depicted in FIG. 8.

The message forwarding window 80 of FIG. 8 is mainly provided for a user to control handling details of delivery of forwarded messages from a Mailminder server. In exemplary window 80, a notation 81 is made identifying the user and/or sourcing mailbox address. A list of selected email messages selected to be Mailminded appears in box 86. A calendar 82 is provided for selection by the user of a delivery date from the Mailminder server. A delivery date and time may also be entered to the objects within box 83. Alternatively, an interval selection object 88 may be provided, and the delivery time to forward the email message(s) can be calculated from the present time from a user's selection.

In the system of the exemplary client provision is made for the attachment of a note to a Mailminded email message. Such a note may be entered into text entry box 84, which note is attached to the email forwarded to the Mailminder service. It may also be desired to send a forwarded Mailminded message to other recipients, whose addresses may be entered in field 85 and which address are appended to the handling details of the message. In this way recipient addresses may be added for particular email messages should the user desire to forward the message to others not included in the default list configurable with the window of FIG. 7. Clicking the ‘apply’ button commits the details displayed, entered or selected and forwards the emails to the Mailminder service.

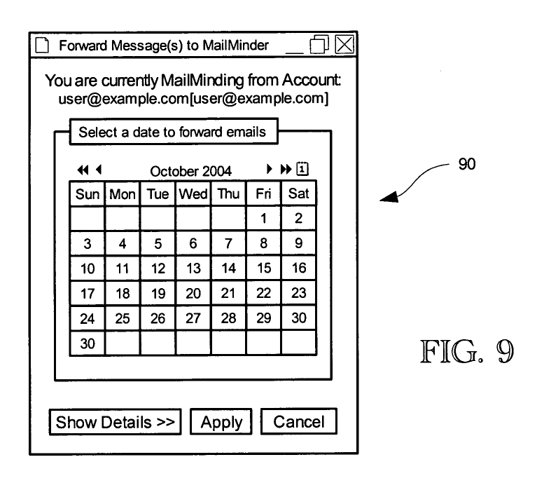

The forward message window 80 may be minimized to the smaller view 90 of FIG. 9 by clicking on the ‘hide details’ button 87. That smaller view displays only a calendar, allowing the user to return to the detailed view if desired.

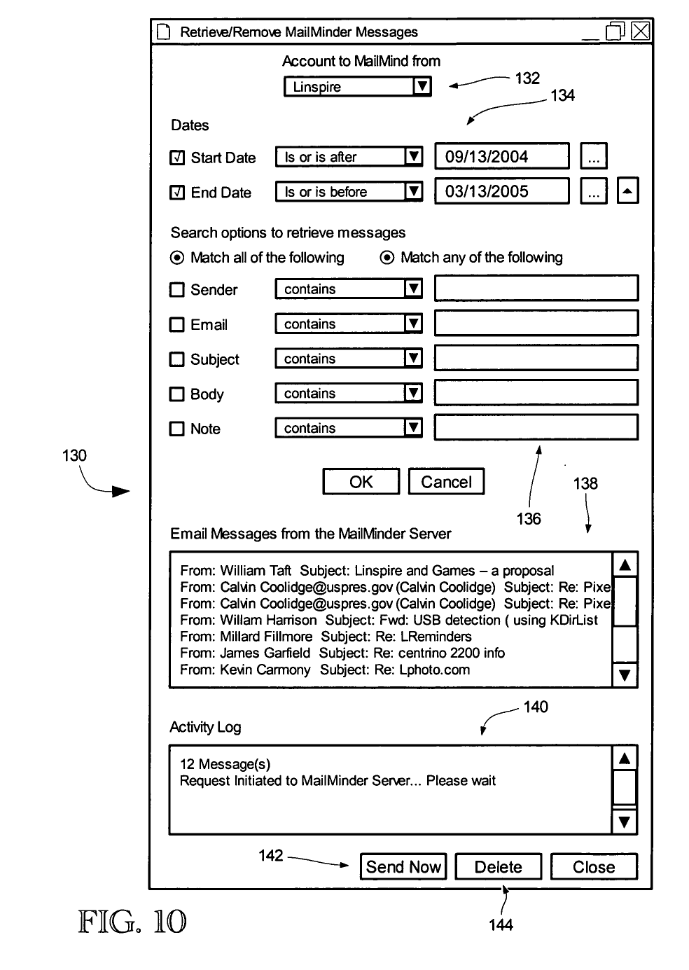

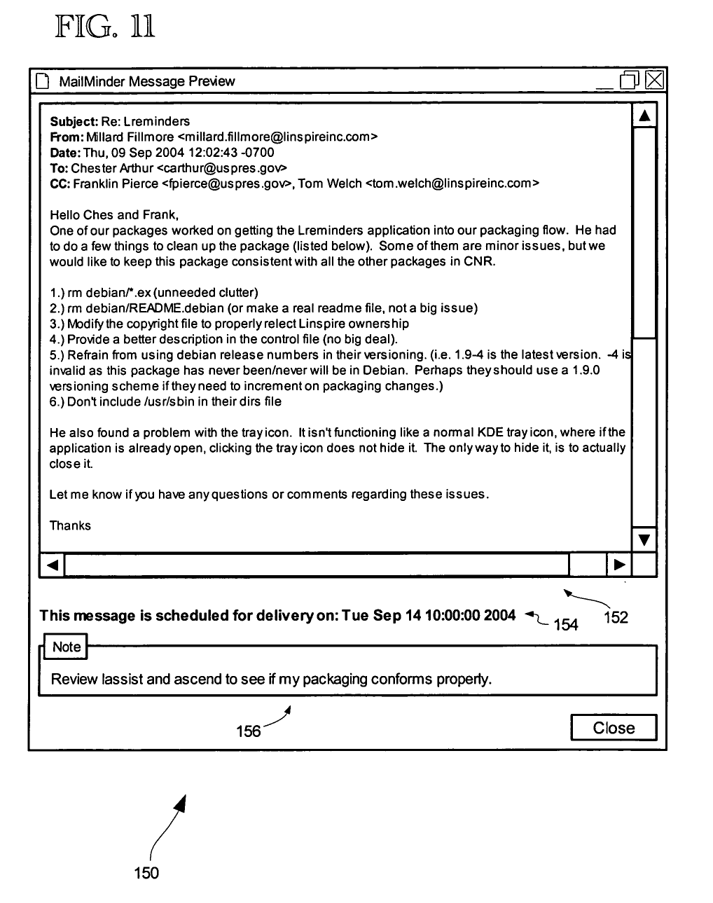

The exemplary email client may connect to a Mailminder service having provision for reviewing messages. This is desirable where forwarded messages are not retained by the client application, and where a user might want to view information from those forwarded messages, particularly where forwarded email messages are not retained by the email client. In the exemplary client, the user may enter the message retrieval display 130 shown in FIG. 10 by selecting the “retrieve/remove messages” option from the menu of FIG. 5 or by pressing shift-R. In that view is a pull-down list 132 permitting selection of an account, which may identify a particular Mailminder service or system. A list of email messages 138 forwarded and stored to the selected Mailminder service is provided. A user may limit the messages listed there by performing a search through the use of date selection objects 134 and textual query entries 136. An activity log 140 is provided to inform the user as to the status of transactions between the email client and Mailminder services. Should a user decide she wishes to forward messages prior to their scheduled delivery times, she can select the messages in the list 138 and press the ‘send now’ button 142. Likewise, she can also select and ‘delete’ 144 messages from the service.

A user might also want to review the contents of an email message stored to a Mailminder service. That may be accomplished by double-clicking an email message from list 138, following which the client presents a view 150 of the selected message as shown in FIG. 11. The email message contents are displayed in a text window 152, with or without attachments. With the email message, the server may return the scheduled delivery time and any attached note, which are displayed as informational items 154 and 156.

One exemplary Mailminder server utilizes an http server executing php scripts. In that system email messages and handling details are stored in a relational database, whereby message search facilities may be implemented utilizing structured queries. The exemplary mailminder service utilizes the cron service to periodically check for pending messages to forward. That service, on finding email messages ready to send, utilizes the SMTP protocol to transfer the messages with headers to recipients, providing a stand-alone service operable with virtually any email service that supports the SMTP protocol.

For the client and server systems and services described above, those may be implemented as software or computer readable instructions located on storage accessible by a processor and executable to perform the functions of those systems and services, providied that sufficient auxiliary hardware is made available such as network facilities, which might be a network adapter and physical connector or other hardware as desired.

While Mailminder systems and systems for forwarding email messages to recipients at a specified later time, with their related methods, have been described and illustrated in conjunction with a number of specific configurations and methods, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

### APPENDIX I

The following is a list of contents of the computer program listing on compact disc, containing files submitted with U.S. Provisional Application No. 60/621,597 filed Oct. 23, 2004 (“mailminder_{—}2004”) and further files of a recent version. Each file or directory in the program listing is listed by size in bytes, a date and time of creation in the listing, and the name of the file or directory. For text-based files, those files are provided with carriage returns and line feeds as required by 37 CFR 1.97(2)(iii) under a directory labeled “dosformattedfiles”, while originally formatted files appear under a directory labeled “code.”

0 2005-10-20 05:12:12 mailminder_{—}2004/

0 2005-10-20 05:12:10 mailminder_{—}2004/code/

0 2005-10-20 05:12:02 mailminder_{—}2004/code/los_source/

0 2005-10-20 05:12:10 mailminder_{—}2004/code/los_source/mailminder/

0 2005-10-20 05:12:02 mailminder_{—}2004/code/los_source/mailminder/base/

0 2005-10-20 05:12:02 mailminder_{—}2004/code/los_source/mailminder/base/cvs/

164 2005-10-20 05:12:02 mailminder_{—}2004/code/los_source/mailminder/base/cvs/Entries

35 2005-10-20 05:12:02 mailminder_{—}2004/code/los_source/mailminder/base/cvs/Repository

41 2005-10-20 05:12:02 mailminder_{—}2004/code/los_source/mailminder/base/cvs/Root

24 2005-10-20 05:12:02 mailminder_{—}2004/code/los_source/mailminder/base/cvs/Tag

2051 2005-10-20 05:12:02 mailminder_{—}2004/code/los_source/mailminder/base/Makefile

2069 2005-10-20 05:12:02 mailminder_{—}2004/code/los_source/mailminder/base/Makefile.in

0 2005-10-20 05:12:02 mailminder_{—}2004/code/los_source/mailminder/base/public/

0 2005-10-20 05:12:02 mailminder_{—}2004/code/los_source/mailminder/base/public/cvs/

225 2005-10-20 05:12:02 mailminder_{—}2004/code/los_source/mailminder/base/public/cvs/Entries

42 2005-10-20 05:12:02 mailminder_{—}2004/code/los_source/mailminder/base/public/cvs/Repository

41 2005-10-20 05:12:02 mailminder_{—}2004/code/los_source/mailminder/base/public/cvs/Root

24 2005-10-20 05:12:02 mailminder_{—}2004/code/los_source/mailminder/base/public/cvs/Tag

1834 2005-10-20 05:12:02 mailminder_{—}2004/code/los_source/mailminder/base/public/Makefile

1849 2005-10-20 05:12:02 mailminder_{—}2004/code/los_source/mailminder/base/public/Makefile.in

2171 2005-10-20 05:12:02 mailminder_{—}2004/code/los_source/mailminder/base/public/mozIMailminder.idl

0 2005-10-20 05:12:02 mailminder_{—}2004/code/los_source/mailminder/base/src/

0 2005-10-20 05:12:02 mailminder_{—}2004/code/los_source/mailminder/base/src/cvs/

303 2005-10-20 05:12:02 mailminder_{—}2004/code/los_source/mailminder/base/src/cvs/Entries

39 2005-10-20 05:12:02 mailminder_{—}2004/code/los_source/mailminder/base/src/cvs/Repository

41 2005-10-20 05:12:02 mailminder_{—}2004/code/los_source/mailminder/base/src/cvs/Root

24 2005-10-20 05:12:02 mailminder_{—}2004/code/los_source/mailminder/base/src/cvs/Tag

1894 2005-10-20 05:12:02 mailminder_{—}2004/code/los_source/mailminder/base/src/Makefile

1909 2005-10-20 05:12:02 mailminder_{—}2004/code/los_source/mailminder/base/src/Makefile.in

2250 2005-10-20 05:12:02 mailminder_{—}2004/code/los_source/mailminder/base/src/mozMailminder.cpp

277 2005-10-20 05:12:02 mailminder_{—}2004/code/los_source/mailminder/base/src/mozMailminder.h

0 2005-10-20 05:12:04 mailminder_{—}2004/code/los_source/mailminder/build/

0 2005-10-20 05:12:04 mailminder_{—}2004/code/los_source/mailminder/build/cvs/

151 2005-10-20 05:12:02 mailminder_{—}2004/code/los_source/mailminder/build/cvs/Entries

36 2005-10-20 05:12:04 mailminder_{—}2004/code/los_source/mailminder/build/cvs/Repository

41 2005-10-20 05:12:04 mailminder_{—}2004/code/los_source/mailminder/build/cvs/Root

24 2005-10-20 05:12:04 mailminder_{—}2004/code/los_source/mailminder/build/cvs/Tag

2044 2005-10-20 05:12:04 mailminder_{—}2004/code/los_source/mailminder/build/Makefile

2062 2005-10-20 05:12:04 mailminder_{—}2004/code/los_source/mailminder/build/Makefile.in

0 2005-10-20 05:12:04 mailminder_{—}2004/code/los_source/mailminder/build/src/

0 2005-10-20 05:12:04 mailminder_{—}2004/code/los_source/mailminder/build/src/cvs/

234 2005-10-20 05:12:04 mailminder_{—}2004/code/los_source/mailminder/build/src/cvs/Entries

40 2005-10-20 05:12:04 mailminder_{—}2004/code/los_source/mailminder/build/src/cvs/Repository

41 2005-10-20 05:12:04 mailminder_{—}2004/code/los_source/mailminder/build/src/cvs/Root

24 2005-10-20 05:12:04 mailminder_{—}2004/code/los_source/mailminder/build/src/cvs/Tag

2220 2005-10-20 05:12:04 mailminder_{—}2004/code/los_source/mailminder/build/src/Makefile

2235 2005-10-20 05:12:04 mailminder_{—}2004/code/los_source/mailminder/build/src/Makefile.in 2198 2005-10-20 05:12:04 mailminder_{—}2004/code/los_source/mailminder/build/src/mozMailminderModule.cpp

0 2005-10-20 05:12:04 mailminder_{—}2004/code/los_source/mailminder/cvs/

417 2005-10-20 05:12:04 mailminder_{—}2004/code/los_source/mailminder/cvs/Entries

30 2005-10-20 05:12:04 mailminder_{—}2004/code/los_source/mailminder/cvs/Repository

41 2005-10-20 05:12:04 mailminder_{—}2004/code/los_source/mailminder/cvs/Root

24 2005-10-20 05:12:04 mailminder_{—}2004/code/los_source/mailminder/cvs/Tag

5672 2005-10-20 05:12:04 mailminder_{—}2004/code/los_source/mailminder/jar.mn

2434 2005-10-20 05:12:04 mailminder_{—}2004/code/los_source/mailminder/Makefile.in

0 2005-10-20 05:12:04 mailminder_{—}2004/code/los_source/mailminder/misc/

431 2005-10-20 05:12:04 mailminder_{—}2004/code/los_source/mailminder/misc/all.entries

0 2005-10-20 05:12:04 mailminder_{—}2004/code/los_source/mailminder/misc/cvs/

153 2005-10-20 05:12:04 mailminder_{—}2004/code/los_source/mailminder/misc/cvs/Entries

35 2005-10-20 05:12:04 mailminder_{—}2004/code/los_source/mailminder/misc/cvs/Repository

41 2005-10-20 05:12:04 mailminder_{—}2004/code/los_source/mailminder/misc/cvs/Root

24 2005-10-20 05:12:04 mailminder_{—}2004/code/los_source/mailminder/misc/cvs/Tag

126 2005-10-20 05:12:04 mailminder_{—}2004/code/los_source/mailminder/misc/installed-chrome.txt

1770 2005-10-20 05:12:04 mailminder_{—}2004/code/los_source/mailminder/readme

0 2005-10-20 05:12:06 mailminder_{—}2004/code/los_source/mailminder/resources/

0 2005-10-20 05:12:06 mailminder_{—}2004/code/los_source/mailminder/resources/content/

3543 2005-10-20 05:12:04 mailminder_{—}2004/code/los_source/mailminder/resources/content/configure.js

2509 2005-10-20 05:12:04 mailminder_{—}2004/code/los_source/mailminder/resources/content/configure.xul

995 2005-10-20 05:12:04 mailminder_{—}2004/code/los_source/mailminder/resources/content/contents.rdf

1002 2005-10-20 05:12:04 mailminder_{—}2004/code/los_source/mailminder/resources/content/contents.rdf.in

0 2005-10-20 05:12:04 mailminder_{—}2004/code/los_source/mailminder/resources/content/cvs/

1852 2005-10-20 05:12:04 mailminder_{—}2004/code/los_source/mailminder/resources/content/cvs/Entries

48 2005-10-20 05:12:04 mailminder_{—}2004/code/los_source/mailminder/resources/content/cvs/Repository

41 2005-10-20 05:12:04 mailminder_{—}2004/code/los_source/mailminder/resources/content/cvs/Root

24 2005-10-20 05:12:04 mailminder_{—}2004/code/los_source/mailminder/resources/content/cvs/Tag

10086 2005-10-20 05:12:04 mailminder_{—}2004/code/los_source/mailminder/resources/content/datepicker.xul

0 2005-10-20 05:12:04 mailminder_{—}2004/code/los_source/mailminder/resources/content/html/

0 2005-10-20 05:12:04 mailminder_{—}2004/code/los_source/mailminder/resources/content/html/cvs/

149 2005-10-20 05:12:04 mailminder_{—}2004/code/los_source/mailminder/resources/content/html/cvs/Entries

53 2005-10-20 05:12:04 mailminder_{—}2004/code/los_source/mailminder/resources/content/html/cvs/Repository

41 2005-10-20 05:12:04 mailminder_{—}2004/code/los_source/mailminder/resources/content/html/cvs/Root

24 2005-10-20 05:12:04 mailminder_{—}2004/code/los_source/mailminder/resources/content/html/cvs/Tag

401 2005-10-20 05:12:04 mailminder_{—}2004/code/los_source/mailminder/resources/content/html/index.html

483 2005-10-20 05:12:04 mailminder_{—}2004/code/los_source/mailminder/resources/content/html/previewError.html

9204 2005-10-20 05:12:04 mailminder_{—}2004/code/los_source/mailminder/resources/content/insertAddresses.js

2589 2005-10-20 05:12:04 mailminder_{—}2004/code/los_source/mailminder/resources/content/insertAddresses.xul

3373 2005-10-20 05:12:04 mailminder_{—}2004/code/los_source/mailminder/resources/content/loginDialog.js

1042 2005-10-20 05:12:06 mailminder_{—}2004/code/los_source/mailminder/resources/content/loginDialog.xul

5053 2005-10-20 05:12:06 mailminder_{—}2004/code/los_source/mailminder/resources/content/mailminder.js

2697 2005-10-20 05:12:06 mailminder_{—}2004/code/los_source/mailminder/resources/content/mailminderOverlay.xul

11463 2005-10-20 05:12:06 mailminder_{—}2004/code/los_source/mailminder/resources/content/mailminder-shared.js

6444 2005-10-20 05:12:06 mailminder_{—}2004/code/los_source/mailminder/resources/content/pickers.xml

598 2005-10-20 05:12:06 mailminder_{—}2004/code/los_source/mailminder/resources/content/progressDialog.js

934 2005-10-20 05:12:06 mailminder_{—}2004/code/los_source/mailminder/resources/content/progressDialog.xul

25702 2005-10-20 05:12:06 mailminder_{—}2004/code/los_source/mailminder/resources/content/winActivateDeactivate.js

4400 2005-10-20 05:12:06 mailminder_{—}2004/code/los_source/mailminder/resources/content/winActivateDeactivate.xul

5222 2005-10-20 05:12:06 mailminder_{—}2004/code/los_source/mailminder/resources/content/winInsert.js

2368 2005-10-20 05:12:06 mailminder_{—}2004/code/los_source/mailminder/resources/content/winInsert.xul

4658 2005-10-20 05:12:06 mailminder_{—}2004/code/los_source/mailminder/resources/content/winPreviewMsg.js

2151 2005-10-20 05:12:06 mailminder_{—}2004/code/los_source/mailminder/resources/content/winPreviewMsg.xul

23019 2005-10-20 05:12:06 mailminder_{—}2004/code/los_source/mailminder/resources/content/winRetrieveRemove.js

11660 2005-10-20 05:12:06 mailminder_{—}2004/code/los_source/mailminder/resources/content/winRetrieveRemove.xul

0 2005-10-20 05:12:06 mailminder_{—}2004/code/los_source/mailminder/resources/cvs/

179 2005-10-20 05:12:06 mailminder_{—}2004/code/los_source/mailminder/resources/cvs/Entries

40 2005-10-20 05:12:06 mailminder_{—}2004/code/los_source/mailminder/resources/cvs/Repository

41 2005-10-20 05:12:06 mailminder_{—}2004/code/los_source/mailminder/resources/cvs/Root

24 2005-10-20 05:12:06 mailminder_{—}2004/code/los_source/mailminder/resources/cvs/Tag

0 2005-10-20 05:12:06 mailminder_{—}2004/code/los_source/mailminder/resources/locale/

0 2005-10-20 05:12:06 mailminder_{—}2004/code/los_source/mailminder/resources/locale/cvs/

12 2005-10-20 05:12:06 mailminder_{—}2004/code/los_source/mailminder/resources/locale/cvs/Entries

47 2005-10-20 05:12:06 mailminder_{—}2004/code/los_source/mailminder/resources/locale/cvs/Repository

41 2005-10-20 05:12:06 mailminder_{—}2004/code/los_source/mailminder/resources/locale/cvs/Root

24 2005-10-20 05:12:06 mailminder_{—}2004/code/los_source/mailminder/resources/locale/cvs/Tag

0 2005-10-20 05:12:06 mailminder_{—}2004/code/los_source/mailminder/resources/locale/en-US/

1355 2005-10-20 05:12:06 mailminder_{—}2004/code/los_source/mailminder/resources/locale/en-US/configure.dtd

1105 2005-10-20 05:12:06 mailminder_{—}2004/code/los_source/mailminder/resources/locale/en-US/contents.rdf

0 2005-10-20 05:12:06 mailminder_{—}2004/code/los_source/mailminder/resources/locale/en-US/cvs/

1028 2005-10-20 05:12:06 mailminder_{—}2004/code/los_source/mailminder/resources/locale/en-US/cvs/Entries

53 2005-10-20 05:12:06 mailminder_{—}2004/code/los_source/mailminder/resources/locale/en-US/cvs/Repository

41 2005-10-20 05:12:06 mailminder_{—}2004/code/los_source/mailminder/resources/locale/en-US/cvs/Root

24 2005-10-20 05:12:06 mailminder_{—}2004/code/los_source/mailminder/resources/locale/en-US/cvs/Tag

838 2005-10-20 05:12:06 mailminder_{—}2004/code/los_source/mailminder/resources/locale/en-US/datepicker.dtd

727 2005-10-20 05:12:06 mailminder_{—}2004/code/los_source/mailminder/resources/locale/en-US/insertAddresses.dtd

286 2005-10-20 05:12:06 mailminder_{—}2004/code/los_source/mailminder/resources/locale/en-US/loginDialog.dtd

462 2005-10-20 05:12:06 mailminder_{—}2004/code/los_source/mailminder/resources/locale/en-US/mailminder.dtd

6024 2005-10-20 05:12:06 mailminder_{—}2004/code/los_source/mailminder/resources/locale/en-US/mailminder.properties

48 2005-10-20 05:12:06 mailminder_{—}2004/code/los_source/mailminder/resources/locale/en-US/pickers.dtd

242 2005-10-20 05:12:06 mailminder_{—}2004/code/los_source/mailminder/resources/locale/en-US/progressDialog.dtd

1465 2005-10-20 05:12:06 mailminder_{—}2004/code/los_source/mailminder/resources/locale/en-US/winActivateDeactivate.dtd

546 2005-10-20 05:12:06 mailminder_{—}2004/code/los_source/mailminder/resources/locale/en-US/winInsert.dtd

212 2005-10-20 05:12:06 mailminder_{—}2004/code/los_source/mailminder/resources/locale/en-US/winPreviewMsg.dtd

1924 2005-10-20 05:12:06 mailminder_{—}2004/code/los_source/mailminder/resources/locale/en-US/winRetrieveRemove.dtd

1762 2005-10-20 05:12:06 mailminder_{—}2004/code/los_source/mailminder/resources/Makefile

1780 2005-10-20 05:12:06 mailminder_{—}2004/code/los_source/mailminder/resources/Makefile.in

0 2005-10-20 05:12:08 mailminder_{—}2004/code/los_source/mailminder/resources/skin/

539 2005-10-20 05:12:06 mailminder_{—}2004/code/los_source/mailminder/resources/skin/contents.rdf

0 2005-10-20 05:12:06 mailminder_{—}2004/code/los_source/mailminder/resources/skin/cvs/

254 2005-10-20 05:12:06 mailminder_{—}2004/code/los_source/mailminder/resources/skin/cvs/Entries

45 2005-10-20 05:12:06 mailminder_{—}2004/code/los_source/mailminder/resources/skin/cvs/Repository

41 2005-10-20 05:12:06 mailminder_{—}2004/code/los_source/mailminder/resources/skin/cvs/Root

24 2005-10-20 05:12:06 mailminder_{—}2004/code/los_source/mailminder/resources/skin/cvs/Tag

2301 2005-10-20 05:12:08 mailminder_{—}2004/code/los_source/mailminder/resources/skin/datepicker.css

0 2005-10-20 05:12:08 mailminder_{—}2004/code/los_source/mailminder/resources/skin/icons/

0 2005-10-20 05:12:08 mailminder_{—}2004/code/los_source/mailminder/resources/skin/icons/cvs/

403 2005-10-20 05:12:08 mailminder_{—}2004/code/los_source/mailminder/resources/skin/icons/cvs/Entries

51 2005-10-20 05:12:08 mailminder_{—}2004/code/los_source/mailminder/resources/skin/icons/cvs/Repository

41 2005-10-20 05:12:08 mailminder_{—}2004/code/los_source/mailminder/resources/skin/icons/cvs/Root

24 2005-10-20 05:12:08 mailminder_{—}2004/code/los_source/mailminder/resources/skin/icons/cvs/Tag

12537 2005-10-20 05:12:08 mailminder_{—}2004/code/los_source/mailminder/resources/skin/icons/mailminder-128.png

505 2005-10-20 05:12:08 mailminder_{—}2004/code/los_source/mailminder/resources/skin/icons/mailminder-16.png

3962 2005-10-20 05:12:08 mailminder_{—}2004/code/los_source/mailminder/resources/skin/icons/mailminder-22.png

3332 2005-10-20 05:12:08 mailminder_{—}2004/code/los_source/mailminder/resources/skin/icons/mailminder-48.png

4930 2005-10-20 05:12:08 mailminder_{—}2004/code/los_source/mailminder/resources/skin/icons/mailminder-64.png

0 2005-10-20 05:12:08 mailminder_{—}2004/code/los_source/mailminder/resources/skin/images/

1019 2005-10-20 05:12:08 mailminder_{—}2004/code/los_source/mailminder/resources/skin/images/calendar.gif

0 2005-10-20 05:12:08 mailminder_{—}2004/code/los_source/mailminder/resources/skin/images/cvs/

2468 2005-10-20 05:12:08 mailminder_{—}2004/code/los_source/mailminder/resources/skin/images/cvs/Entries

52 2005-10-20 05:12:08 mailminder_{—}2004/code/los_source/mailminder/resources/skin/images/cvs/Repository

41 2005-10-20 05:12:08 mailminder_{—}2004/code/los_source/mailminder/resources/skin/images/cvs/Root

24 2005-10-20 05:12:08 mailminder_{—}2004/code/los_source/mailminder/resources/skin/images/cvs/Tag

212 2005-10-20 05:12:08 mailminder_{—}2004/code/los_source/mailminder/resources/skin/images/da.png

187 2005-10-20 05:12:08 mailminder_{—}2004/code/los_source/mailminder/resources/skin/images/la.png

198 2005-10-20 05:12:08 mailminder_{—}2004/code/los_source/mailminder/resources/skin/images/lda.png

816 2005-10-20 05:12:08 mailminder_{—}2004/code/los_source/mailminder/resources/skin/images/mm-calmback.png

674 2005-10-20 05:12:08 mailminder_{—}2004/code/los_source/mailminder/resources/skin/images/mm-calmback-disabled.png

839 2005-10-20 05:12:08 mailminder_{—}2004/code/los_source/mailminder/resources/skin/images/mm-calmback-hover.png

830 2005-10-20 05:12:08 mailminder_{—}2004/code/los_source/mailminder/resources/skin/images/mm-calmfwd.png

692 2005-10-20 05:12:08 mailminder_{—}2004/code/los_source/mailminder/resources/skin/images/mm-calmfwd-disabled.png

859 2005-10-20 05:12:08 mailminder_{—}2004/code/los_source/mailminder/resources/skin/images/mm-calmfwd-hover.png

696 2005-10-20 05:12:08 mailminder_{—}2004/code/los_source/mailminder/resources/skin/images/mm-caltoday.png

743 2005-10-20 05:12:08 mailminder_{—}2004/code/los_source/mailminder/resources/skin/images/mm-caltoday-hover.png

637 2005-10-20 05:12:08 mailminder_{—}2004/code/los_source/mailminder/resources/skin/images/mm-calyback.png

596 2005-10-20 05:12:08 mailminder_{—}2004/code/los_source/mailminder/resources/skin/images/mm-calyback-disabled.png

648 2005-10-20 05:12:08 mailminder_{—}2004/code/los_source/mailminder/resources/skin/images/mm-calyback-hover.png

664 2005-10-20 05:12:08 mailminder_{—}2004/code/los_source/mailminder/resources/skin/images/mm-calyfwd.png

586 2005-10-20 05:12:08 mailminder_{—}2004/code/los_source/mailminder/resources/skin/images/mm-calyfwd-disabled.png

668 2005-10-20 05:12:08 mailminder_{—}2004/code/los_source/mailminder/resources/skin/images/mm-calyfwd-hover.png

340 2005-10-20 05:12:08 mailminder_{—}2004/code/los_source/mailminder/resources/skin/images/mm-downarrow.png

323 2005-10-20 05:12:08 mailminder_{—}2004/code/los_source/mailminder/resources/skin/images/mm-downarrow-disabled.png

347 2005-10-20 05:12:08 mailminder_{—}2004/code/los_source/mailminder/resources/skin/images/mm-downarrow-hover.png

475 2005-10-20 05:12:08 mailminder_{—}2004/code/los_source/mailminder/resources/skin/images/mm-hidoptions.png

477 2005-10-20 05:12:08 mailminder_{—}2004/code/los_source/mailminder/resources/skin/images/mm-hidoptions-hover.png

466 2005-10-20 05:12:08 mailminder_{—}2004/code/los_source/mailminder/resources/skin/images/mm-showoptions.png

461 2005-10-20 05:12:08 mailminder_{—}2004/code/los_source/mailminder/resources/skin/images/mm-showoptions-hover.png

332 2005-10-20 05:12:08 mailminder_{—}2004/code/los_source/mailminder/resources/skin/images/mm-uparrow.png

327 2005-10-20 05:12:08 mailminder_{—}2004/code/los_source/mailminder/resources/skin/images/mm-uparrow-disabled.png

341 2005-10-20 05:12:08 mailminder_{—}2004/code/los_source/mailminder/resources/skin/images/mm-uparrow-hover.png

186 2005-10-20 05:12:08 mailminder_{—}2004/code/los_source/mailminder/resources/skin/images/ra.png

200 2005-10-20 05:12:08 mailminder_{—}2004/code/los_source/mailminder/resources/skin/images/rda.png

201 2005-10-20 05:12:08 mailminder_{—}2004/code/los_source/mailminder/resources/skin/images/ua.png

2714 2005-10-20 05:12:08 mailminder_{—}2004/code/los_source/mailminder/resources/skin/mailminder.css

0 2005-10-20 05:12:10 mailminder_{—}2004/code/los_source/mailminder/scripts/

436 2005-10-20 05:12:08 mailminder_{—}2004/code/los_source/mailminder/scripts/build_hooks.sh

564 2005-10-20 05:12:10 mailminder_{—}2004/code/los_source/mailminder/scripts/build_xpi.sh

0 2005-10-20 05:12:10 mailminder_{—}2004/code/los_source/mailminder/scripts/cvs/

589 2005-10-20 05:12:10 mailminder_{—}2004/code/los_source/mailminder/scripts/cvs/Entries

38 2005-10-20 05:12:10 mailminder_{—}2004/code/los_source/mailminder/scripts/cvs/Repository

41 2005-10-20 05:12:10 mailminder_{—}2004/code/los_source/mailminder/scripts/cvs/Root

24 2005-10-20 05:12:10 mailminder_{—}2004/code/los_source/mailminder/scripts/cvs/Tag

4180 2005-10-20 05:12:10 mailminder_{—}2004/code/los_source/mailminder/scripts/install.js.in

225 2005-10-20 05:12:10 mailminder_{—}2004/code/los_source/mailminder/scripts/mailminder.js

94 2005-10-20 05:12:10 mailminder_{—}2004/code/los_source/mailminder/scripts/move_xpi.sh

1117 2005-10-20 05:12:10 mailminder_{—}2004/code/los_source/mailminder/scripts/project_init.sh

903 2005-10-20 05:12:10 mailminder_{—}2004/code/los_source/mailminder/scripts/version

5 2005-10-20 05:12:10 mailminder_{—}2004/code/los_source/mailminder/version

0 2005-10-20 05:12:10 mailminder_{—}2004/code/mailminder/

0 2005-10-20 05:12:10 mailminder_{—}2004/code/mailminder/php_mm/

773 2005-10-20 05:12:10 mailminder_{—}2004/code/mailminder/php_mm/authentication.php

787 2005-10-20 05:12:10 mailminder_{—}2004/code/mailminder/php_mm/buy_service_response.php

75 2005-10-20 05:12:10 mailminder_{—}2004/code/mailminder/php_mm/cron_mm_lindows.txt

58 2005-10-20 05:12:10 mailminder_{—}2004/code/mailminder/php_mm/cron_mm_sti.txt

0 2005-10-20 05:12:10 mailminder_{—}2004/code/mailminder/php_mm/cvs/

827 2005-10-20 05:12:10 mailminder_{—}2004/code/mailminder/php_mm/cvs/Entries

33 2005-10-20 05:12:10 mailminder_{—}2004/code/mailminder/php_mm/cvs/Repository

24 2005-10-20 05:12:10 mailminder_{—}2004/code/mailminder/php_mm/cvs/Root

6156 2005-10-20 05:12:10 mailminder_{—}2004/code/mailminder/php_mm/findmsg.php

517 2005-10-20 05:12:10 mailminder_{—}2004/code/mailminder/php_mm/log_in_response.php

0 2005-10-20 05:12:10 mailminder_{—}2004/code/mailminder/php_mm/Mail/

0 2005-10-20 05:12:10 mailminder_{—}2004/code/mailminder/php_mm/Mail/cvs/

397 2005-10-20 05:12:10 mailminder_{—}2004/code/mailminder/php_mm/Mail/cvs/Entries

38 2005-10-20 05:12:10 mailminder_{—}2004/code/mailminder/php_mm/Mail/cvs/Repository

24 2005-10-20 05:12:10 mailminder_{—}2004/code/mailminder/php_mm/Mail/cvs/Root

7460 2005-10-20 05:12:10 mailminder_{—}2004/code/mailminder/php_mm/Mail/Mail.php

7444 2005-10-20 05:12:10 mailminder_{—}2004/code/mailminder/php_mm/Mail/MailMinder.inc

7605 2005-10-20 05:12:10 mailminder_{—}2004/code/mailminder/php_mm/Mail/MailMinderTEST.inc

23734 2005-10-20 05:12:10 mailminder_{—}2004/code/mailminder/php_mm/Mail/mime.php

33585 2005-10-20 05:12:10 mailminder_{—}2004/code/mailminder/php_mm/Mail/mimeDecode.php

12910 2005-10-20 05:12:10 mailminder_{—}2004/code/mailminder/php_mm/Mail/mimePart.php

28559 2005-10-20 05:12:10 mailminder_{—}2004/code/mailminder/php_mm/Mail/PEAR.php

31384 2005-10-20 05:12:10 mailminder_{—}2004/code/mailminder/php_mm/Mail/RFC822.php

3010 2005-10-20 05:12:10 mailminder_{—}2004/code/mailminder/php_mm/Mail/SendMail.php

8371 2005-10-20 05:12:10 mailminder_{—}2004/code/mailminder/php_mm/Mail/smtpMail.php

3215 2005-10-20 05:12:10 mailminder_{—}2004/code/mailminder/php_mm/mailCheck.php

1212 2005-10-20 05:12:10 mailminder_{—}2004/code/mailminder/php_mm/MailMinder.sql

599 2005-10-20 05:12:10 mailminder_{—}2004/code/mailminder/php_mm/mm_login.php

5819 2005-10-20 05:12:10 mailminder_{—}2004/code/mailminder/php_mm/previewmsg.php

758 2005-10-20 05:12:10 mailminder_{—}2004/code/mailminder/php_mm/removemsg.php

2654 2005-10-20 05:12:10 mailminder_{—}2004/code/mailminder/php_mm/retmsg.php

3042 2005-10-20 05:12:10 mailminder_{—}2004/code/mailminder/php_mm/sendnowrequest.php

3087 2005-10-20 05:12:10 mailminder_{—}2004/code/mailminder/php_mm/sendnowrequest_test.php

2172 2005-10-20 05:12:10 mailminder_{—}2004/code/mailminder/php_mm/textgetmail.php

6196 2005-10-20 05:12:10 mailminder_{—}2004/code/mailminder/php_mm/xmlMailpro.php

0 2005-10-20 05:12:18 mailminder_{—}2004/dosformattedfiles/

0 2005-10-20 05:12:12 mailminder_{—}2004/dosformattedfiles/los_source/

0 2005-10-20 05:12:18 mailminder_{—}2004/dosformattedfiles/los_source/mailminder/

0 2005-10-20 05:12:12 mailminder_{—}2004/dosformattedfiles/los_source/mailminder/base/

0 2005-10-20 05:12:12 mailminder_{—}2004/dosformattedfiles/los_source/mailminder/base/cvs/

169 2005-10-20 05:12:12 mailminder_{—}2004/dosformattedfiles/los_source/mailminder/base/cvs/Entries

37 2005-10-20 05:12:12 mailminder_{—}2004/dosformattedfiles/los_source/mailminder/base/cvs/Repository

43 2005-10-20 05:12:12 mailminder_{—}2004/dosformattedfiles/los_source/mailminder/base/cvs/Root

26 2005-10-20 05:12:12 mailminder_{—}2004/dosformattedfiles/los_source/mailminder/base/cvs/Tag

2097 2005-10-20 05:12:12 mailminder_{—}2004/dosformattedfiles/los_source/mailminder/base/Makefile

2115 2005-10-20 05:12:12 mailminder_{—}2004/dosformattedfiles/los_source/mailminder/base/Makefile.in

0 2005-10-20 05:12:12 mailminder_{—}2004/dosformattedfiles/los_source/mailminder/base/public/

0 2005-10-20 05:12:12 mailminder_{—}2004/dosformattedfiles/los_source/mailminder/base/public/cvs/

230 2005-10-20 05:12:12 mailminder_{—}2004/dosformattedfiles/los_source/mailminder/base/public/cvs/Entries

44 2005-10-20 05:12:12 mailminder_{—}2004/dosformattedfiles/los_source/mailminder/base/public/cvs/Repository

43 2005-10-20 05:12:12 mailminder_{—}2004/dosformattedfiles/los_source/mailminder/base/public/cvs/Root

26 2005-10-20 05:12:12 mailminder_{—}2004/dosformattedfiles/los_source/mailminder/base/public/cvs/Tag

1884 2005-10-20 05:12:12 mailminder_{—}2004/dosformattedfiles/los_source/mailminder/base/public/Makefile

1899 2005-10-20 05:12:12 mailminder_{—}2004/dosformattedfiles/los_source/mailminder/base/public/Makefile.in

2220 2005-10-20 05:12:12 mailminder_{—}2004/dosformattedfiles/los_source/mailminder/base/public/mozIMailminder.idl

0 2005-10-20 05:12:12 mailminder_{—}2004/dosformattedfiles/los_source/mailminder/base/src/

0 2005-10-20 05:12:12 mailminder_{—}2004/dosformattedfiles/los_source/mailminder/base/src/cvs/

309 2005-10-20 05:12:12 mailminder_{—}2004/dosformattedfiles/los_source/mailminder/base/src/cvs/Entries

41 2005-10-20 05:12:12 mailminder_{—}2004/dosformattedfiles/los_source/mailminder/base/src/cvs/Repository

43 2005-10-20 05:12:12 mailminder_{—}2004/dosformattedfiles/los_source/mailminder/base/src/cvs/Root

26 2005-10-20 05:12:12 mailminder_{—}2004/dosformattedfiles/los_source/mailminder/base/src/cvs/Tag

1951 2005-10-20 05:12:12 mailminder_{—}2004/dosformattedfiles/los_source/mailminder/base/src/Makefile

1966 2005-10-20 05:12:12 mailminder_{—}2004/dosformattedfiles/los_source/mailminder/base/src/Makefile.in

2325 2005-10-20 05:12:12 mailminder_{—}2004/dosformattedfiles/los_source/mailminder/base/src/mozMailminder.cpp

302 2005-10-20 05:12:12 mailminder_{—}2004/dosformattedfiles/los_source/mailminder/base/src/mozMailminder.h

0 2005-10-20 05:12:12 mailminder_{—}2004/dosformattedfiles/los_source/mailminder/build/

0 2005-10-20 05:12:12 mailminder_{—}2004/dosformattedfiles/los_source/mailminder/build/cvs/

155 2005-10-20 05:12:12 mailminder_{—}2004/dosformattedfiles/los_source/mailminder/build/cvs/Entries

38 2005-10-20 05:12:12 mailminder_{—}2004/dosformattedfiles/los_source/mailminder/build/cvs/Repository

43 2005-10-20 05:12:12 mailminder_{—}2004/dosformattedfiles/los_source/mailminder/build/cvs/Root

26 2005-10-20 05:12:12 mailminder_{—}2004/dosformattedfiles/los_source/mailminder/build/cvs/Tag

2090 2005-10-20 05:12:12 mailminder_{—}2004/dosformattedfiles/los_source/mailminder/build/Makefile

2108 2005-10-20 05:12:12 mailminder_{—}2004/dosformattedfiles/los_source/mailminder/build/Makefile.in

0 2005-10-20 05:12:12 mailminder_{—}2004/dosformattedfiles/los_source/mailminder/build/src/

0 2005-10-20 05:12:12 mailminder_{—}2004/dosformattedfiles/los_source/mailminder/build/src/cvs/

239 2005-10-20 05:12:12 mailminder_{—}2004/dosformattedfiles/los_source/mailminder/build/src/cvs/Entries

42 2005-10-20 05:12:12 mailminder_{—}2004/dosformattedfiles/los_source/mailminder/build/src/cvs/Repository

43 2005-10-20 05:12:12 mailminder_{—}2004/dosformattedfiles/los_source/mailminder/build/src/cvs/Root

26 2005-10-20 05:12:12 mailminder_{—}2004/dosformattedfiles/los_source/mailminder/build/src/cvs/Tag

2291 2005-10-20 05:12:12 mailminder_{—}2004/dosformattedfiles/los_source/mailminder/build/src/Makefile

2306 2005-10-20 05:12:12 mailminder_{—}2004/dosformattedfiles/los_source/mailminder/build/src/Makefile.in

2254 2005-10-20 05:12:12 mailminder_{—}2004/dosformattedfiles/los_source/mailminder/build/src/mozMailminderModule.cpp

0 2005-10-20 05:12:12 mailminder_{—}2004/dosformattedfiles/los_source/mailminder/cvs/

428 2005-10-20 05:12:12 mailminder_{—}2004/dosformattedfiles/los_source/mailminder/cvs/Entries

32 2005-10-20 05:12:12 mailminder_{—}2004/dosformattedfiles/los_source/mailminder/cvs/Repository

43 2005-10-20 05:12:12 mailminder_{—}2004/dosformattedfiles/los_source/mailminder/cvs/Root

26 2005-10-20 05:12:12 mailminder_{—}2004/dosformattedfiles/los_source/mailminder/cvs/Tag

5739 2005-10-20 05:12:12 mailminder_{—}2004/dosformattedfiles/los_source/mailminder/jar.mn

2513 2005-10-20 05:12:12 mailminder_{—}2004/dosformattedfiles/los_source/mailminder/Makefile.in

0 2005-10-20 05:12:14 mailminder_{—}2004/dosformattedfiles/los_source/mailminder/misc/

441 2005-10-20 05:12:12 mailminder_{—}2004/dosformattedfiles/los_source/mailminder/misc/all.entries

0 2005-10-20 05:12:14 mailminder_{—}2004/dosformattedfiles/los_source/mailminder/misc/cvs/

157 2005-10-20 05:12:14 mailminder_{—}2004/dosformattedfiles/los_source/mailminder/misc/cvs/Entries

37 2005-10-20 05:12:14 mailminder_{—}2004/dosformattedfiles/los_source/mailminder/misc/cvs/Repository

43 2005-10-20 05:12:14 mailminder_{—}2004/dosformattedfiles/los_source/mailminder/misc/cvs/Root

26 2005-10-20 05:12:14 mailminder_{—}2004/dosformattedfiles/los_source/mailminder/misc/cvs/Tag

129 2005-10-20 05:12:14 mailminder_{—}2004/dosformattedfiles/los_source/mailminder/misc/installed-chrome.txt

1822 2005-10-20 05:12:14 mailminder_{—}2004/dosformattedfiles/los_source/mailminder/readme

0 2005-10-20 05:12:16 mailminder_{—}2004/dosformattedfiles/los_source/mailminder/resources/

0 2005-10-20 05:12:14 mailminder_{—}2004/dosformattedfiles/los_source/mailminder/resources/content/

3695 2005-10-20 05:12:14 mailminder_{—}2004/dosformattedfiles/los_source/mailminder/resources/content/configure.js

2574 2005-10-20 05:12:14 mailminder_{—}2004/dosformattedfiles/los_source/mailminder/resources/content/configure.xul

1023 2005-10-20 05:12:14 mailminder_{—}2004/dosformattedfiles/los_source/mailminder/resources/content/contents.rdf

1030 2005-10-20 05:12:14 mailminder_{—}2004/dosformattedfiles/los_source/mailminder/resources/content/contents.rdf.in

0 2005-10-20 05:12:14 mailminder_{—}2004/dosformattedfiles/los_source/mailminder/resources/content/cvs/

1877 2005-10-20 05:12:14 mailminder_{—}2004/dosformattedfiles/los_source/mailminder/resources/content/cvs/Entries

50 2005-10-20 05:12:14 mailminder_{—}2004/dosformattedfiles/los_source/mailminder/resources/content/cvs/Repository

43 2005-10-20 05:12:14 mailminder_{—}2004/dosformattedfiles/los_source/mailminder/resources/content/cvs/Root

26 2005-10-20 05:12:14 mailminder_{—}2004/dosformattedfiles/los_source/mailminder/resources/content/cvs/Tag

10474 2005-10-20 05:12:14 mailminder_{—}2004/dosformattedfiles/los_source/mailminder/resources/content/datepicker.xul

0 2005-10-20 05:12:14 mailminder_{—}2004/dosformattedfiles/los_source/mailminder/resources/content/html/

0 2005-10-20 05:12:14 mailminder_{—}2004/dosformattedfiles/los_source/mailminder/resources/content/html/cvs/

153 2005-10-20 05:12:14 mailminder_{—}2004/dosformattedfiles/los_source/mailminder/resources/content/html/cvs/Entries

55 2005-10-20 05:12:14 mailminder_{—}2004/dosformattedfiles/los_source/mailminder/resources/content/html/cvs/Repository

43 2005-10-20 05:12:14 mailminder_{—}2004/dosformattedfiles/los_source/mailminder/resources/content/html/cvs/Root

26 2005-10-20 05:12:14 mailminder_{—}2004/dosformattedfiles/los_source/mailminder/resources/content/html/cvs/Tag

420 2005-10-20 05:12:14 mailminder_{—}2004/dosformattedfiles/los_source/mailminder/resources/content/html/index.html

505 2005-10-20 05:12:14 mailminder_{—}2004/dosformattedfiles/los_source/mailminder/resources/content/html/previewError.html

9549 2005-10-20 05:12:14 mailminder_{—}2004/dosformattedfiles/los_source/mailminder/resources/content/insertAddresses.js

2658 2005-10-20 05:12:14 mailminder_{—}2004/dosformattedfiles/los_source/mailminder/resources/content/insertAddresses.xul

3496 2005-10-20 05:12:14 mailminder_{—}2004/dosformattedfiles/los_source/mailminder/resources/content/loginDialog.js

1073 2005-10-20 05:12:14 mailminder_{—}2004/dosformattedfiles/los_source/mailminder/resources/content/loginDialog.xul

5203 2005-10-20 05:12:14 mailminder_{—}2004/dosformattedfiles/los_source/mailminder/resources/content/mailminder.js

2769 2005-10-20 05:12:14 mailminder_{—}2004/dosformattedfiles/los_source/mailminder/resources/content/mailminderOverlay.xul

11826 2005-10-20 05:12:14 mailminder_{—}2004/dosformattedfiles/los_source/mailminder/resources/content/mailminder-shared.js

6661 2005-10-20 05:12:14 mailminder_{—}2004/dosformattedfiles/los_source/mailminder/resources/content/pickers.xml

637 2005-10-20 05:12:14 mailminder_{—}2004/dosformattedfiles/los_source/mailminder/resources/content/progressDialog.js

968 2005-10-20 05:12:14 mailminder_{—}2004/dosformattedfiles/los_source/mailminder/resources/content/progressDialog.xul

26579 2005-10-20 05:12:14 mailminder_{—}2004/dosformattedfiles/los_source/mailminder/resources/content/winActivateDeactivate.js

4508 2005-10-20 05:12:14 mailminder_{—}2004/dosformattedfiles/los_source/mailminder/resources/content/winActivateDeactivate.xul

5415 2005-10-2005:12:14 mailminder_{—}2004/dosformattedfiles/los_source/mailminder/resources/content/winInsert.js

2434 2005-10-20 05:12:14 mailminder_{—}2004/dosformattedfiles/los_source/mailminder/resources/content/winInsert.xul

4853 2005-10-20 05:12:14 mailminder_{—}2004/dosformattedfiles/los_source/mailminder/resources/content/winPreviewMsg.js

2218 2005-10-20 05:12:14 mailminder_{—}2004/dosformattedfiles/los_source/mailminder/resources/content/winPreviewMsg.xul

23817 2005-10-20 05:12:14 mailminder_{—}2004/dosformattedfiles/los_source/mailminder/resources/content/winRetrieveRemove.js

11930 2005-10-20 05:12:14 mailminder_{—}2004/dosformattedfiles/los_source/mailminder/resources/content/winRetrieveRemove.xul

0 2005-10-20 05:12:14 mailminder_{—}2004/dosformattedfiles/los_source/mailminder/resources/cvs/

185 2005-10-20 05:12:14 mailminder_{—}2004/dosformattedfiles/los_source/mailminder/resources/cvs/Entries

42 2005-10-20 05:12:14 mailminder_{—}2004/dosformattedfiles/los_source/mailminder/resources/cvs/Repository

43 2005-10-20 05:12:14 mailminder_{—}2004/dosformattedfiles/los_source/mailminder/resources/cvs/Root

26 2005-10-20 05:12:14 mailminder_{—}2004/dosformattedfiles/los_source/mailminder/resources/cvs/Tag

0 2005-10-20 05:12:16 mailminder_{—}2004/dosformattedfiles/los_source/mailminder/resources/locale/

0 2005-10-20 05:12:14 mailminder_{—}2004/dosformattedfiles/los_source/mailminder/resources/locale/cvs/

14 2005-10-20 05:12:14 mailminder_{—}2004/dosformattedfiles/los_source/mailminder/resources/locale/cvs/Entries

49 2005-10-20 05:12:14 mailminder_{—}2004/dosformattedfiles/los_source/mailminder/resources/locale/cvs/Repository

43 2005-10-20 05:12:14 mailminder_{—}2004/dosformattedfiles/los_source/mailminder/resources/locale/cvs/Root

26 2005-10-20 05:12:14 mailminder_{—}2004/dosformattedfiles/los_source/mailminder/resources/locale/cvs/Tag

0 2005-10-20 05:12:16 mailminder_{—}2004/dosformattedfiles/los_source/mailminder/resources/locale/en-US/

1378 2005-10-20 05:12:16 mailminder_{—}2004/dosformattedfiles/los_source/mailminder/resources/locale/en-US/configure.dtd

1130 2005-10-20 05:12:16 mailminder_{—}2004/dosformattedfiles/los_source/mailminder/resources/locale/en-US/contents.rdf

0 2005-10-20 05:12:16 mailminder_{—}2004/dosformattedfiles/los_source/mailminder/resources/locale/en-US/cvs/

1043 2005-10-20 05:12:16 mailminder_{—}2004/dosformattedfiles/los_source/mailminder/resources/locale/en-US/cvs/Entries

55 2005-10-20 05:12:16 mailminder_{—}2004/dosformattedfiles/los_source/mailminder/resources/locale/en-US/cvs/Repository

43 2005-10-20 05:12:16 mailminder_{—}2004/dosformattedfiles/los_source/mailminder/resources/locale/en-US/cvs/Root

26 2005-10-20 05:12:16 mailminder_{—}2004/dosformattedfiles/los_source/mailminder/resources/locale/en-US/cvs/Tag

867 2005-10-20 05:12:16 mailminder_{—}2004/dosformattedfiles/los_source/mailminder/resources/locale/en-US/datepicker.dtd

744 2005-10-20 05:12:16 mailminder_{—}2004/dosformattedfiles/los_source/mailminder/resources/locale/en-US/insertAddresses.dtd

294 2005-10-20 05:12:16 mailminder_{—}2004/dosformattedfiles/los_source/mailminder/resources/locale/en-US/loginDialog.dtd

474 2005-10-20 05:12:16 mailminder_{—}2004/dosformattedfiles/los_source/mailminder/resources/locale/en-US/mailminder.dtd

6113 2005-10-20 05:12:16 mailminder_{—}2004/dosformattedfiles/los_source/mailminder/resources/locale/en-US/mailminder.properties

51 2005-10-20 05:12:16 mailminder_{—}2004/dosformattedfiles/los_source/mailminder/resources/locale/en-US/pickers.dtd

248 2005-10-20 05:12:16 mailminder_{—}2004/dosformattedfiles/los_source/mailminder/resources/locale/en-US/progressDialog.dtd

1494 2005-10-20 05:12:16 mailminder_{—}2004/dosformattedfiles/los_source/mailminder/resources/locale/en-US/winActivateDeactivate.dtd

559 2005-10-20 05:12:16 mailminder_{—}2004/dosformattedfiles/los_source/mailminder/resources/locale/en-US/winInsert.dtd

217 2005-10-20 05:12:16 mailminder_{—}2004/dosformattedfiles/los_source/mailminder/resources/locale/en-US/winPreviewMsg.dtd

1967 2005-10-20 05:12:16 mailminder_{—}2004/dosformattedfiles/los_source/mailminder/resources/locale/en-US/winRetrieveRemove.dtd

1809 2005-10-20 05:12:16 mailminder_{—}2004/dosformattedfiles/los_source/mailminder/resources/Makefile

1827 2005-10-20 05:12:16 mailminder_{—}2004/dosformattedfiles/los_source/mailminder/resources/Makefile.in

0 2005-10-20 05:12:16 mailminder_{—}2004/dosformattedfiles/los_source/mailminder/resources/skin/

554 2005-10-20 05:12:16 mailminder_{—}2004/dosformattedfiles/los_source/mailminder/resources/skin/contents.rdf

0 2005-10-20 05:12:16 mailminder_{—}2004/dosformattedfiles/los_source/mailminder/resources/skin/cvs/

260 2005-10-20 05:12:16 mailminder_{—}2004/dosformattedfiles/los_source/mailminder/resources/skin/cvs/Entries

47 2005-10-20 05:12:16 mailminder_{—}2004/dosformattedfiles/los_source/mailminder/resources/skin/cvs/Repository

43 2005-10-20 05:12:16 mailminder_{—}2004/dosformattedfiles/los_source/mailminder/resources/skin/cvs/Root

26 2005-10-20 05:12:16 mailminder_{—}2004/dosformattedfiles/los_source/mailminder/resources/skin/cvs/Tag

2451 2005-10-2005:12:16 mailminder_{—}2004/dosformattedfiles/los_source/mailminder/resources/skin/datepicker.css

0 2005-10-20 05:12:16 mailminder_{—}2004/dosformattedfiles/los_source/mailminder/resources/skin/icons/

0 2005-10-20 05:12:16 mailminder_{—}2004/dosformattedfiles/los_source/mailminder/resources/skin/icons/cvs/

410 2005-10-20 05:12:16 mailminder_{—}2004/dosformattedfiles/los_source/mailminder/resources/skin/icons/cvs/Entries

53 2005-10-20 05:12:16 mailminder_{—}2004/dosformattedfiles/los_source/mailminder/resources/skin/icons/cvs/Repository

43 2005-10-20 05:12:16 mailminder_{—}2004/dosformattedfiles/los_source/mailminder/resources/skin/icons/cvs/Root

26 2005-10-20 05:12:16 mailminder_{—}2004/dosformattedfiles/los_source/mailminder/resources/skin/icons/cvs/Tag

0 2005-10-20 05:12:16 mailminder_{—}2004/dosformattedfiles/los_source/mailminder/resources/skin/images/

0 2005-10-20 05:12:16 mailminder_{—}2004/dosformattedfiles/los_source/mailminder/resources/skin/images/cvs/

2501 2005-10-20 05:12:16 mailminder_{—}2004/dosformattedfiles/los_source/mailminder/resources/skin/images/cvs/Entries

54 2005-10-20 05:12:16 mailminder_{—}2004/dosformattedfiles/los_source/mailminder/resources/skin/images/cvs/Repository

43 2005-10-20 05:12:16 mailminder_{—}2004/dosformattedfiles/los_source/mailminder/resources/skin/images/cvs/Root

26 2005-10-20 05:12:16 mailminder_{—}2004/dosformattedfiles/los_source/mailminder/resources/skin/images/cvs/Tag

2834 2005-10-20 05:12:16 mailminder_{—}2004/dosformattedfiles/los_source/mailminder/resources/skin/mailminder.css

0 2005-10-20 05:12:18 mailminder_{—}2004/dosformattedfiles/los_source/mailminder/scripts/

462 2005-10-20 05:12:16 mailminder_{—}2004/dosformattedfiles/los_source/mailminder/scripts/build_hooks.sh

596 2005-10-20 05:12:16 mailminder_{—}2004/dosformattedfiles/los_source/mailminder/scripts/build_xpi.sh

0 2005-10-20 05:12:16 mailminder_{—}2004/dosformattedfiles/los_source/mailminder/scripts/cvs/

599 2005-10-20 05:12:16 mailminder_{—}2004/dosformattedfiles/los_source/mailminder/scripts/cvs/Entries

40 2005-10-20 05:12:16 mailminder_{—}2004/dosformattedfiles/los_source/mailminder/scripts/cvs/Repository

43 2005-10-20 05:12:16 mailminder_{—}2004/dosformattedfiles/los_source/mailminder/scripts/cvs/Root

26 2005-10-20 05:12:16 mailminder_{—}2004/dosformattedfiles/los_source/mailminder/scripts/cvs/Tag

4327 2005-10-20 05:12:16 mailminder_{—}2004/dosformattedfiles/los_source/mailminder/scripts/install.js.in

233 2005-10-20 05:12:16 mailminder_{—}2004/dosformattedfiles/los_source/mailminder/scripts/mailminder.js

101 2005-10-20 05:12:18 mailminder_{—}2004/dosformattedfiles/los_source/mailminder/scripts/move_xpi.sh

1158 2005-10-20 05:12:18 mailminder_{—}2004/dosformattedfiles/los_source/mailminder/scripts/project_init.sh

947 2005-10-20 05:12:18 mailminder_{—}2004/dosformattedfiles/los_source/mailminder/scripts/version

7 2005-10-20 05:12:18 mailminder_{—}2004/dosformattedfiles/los_source/mailminder/version

0 2005-10-20 05:12:18 mailminder_{—}2004/dosformattedfiles/mailminder/

0 2005-10-20 05:12:18 mailminder_{—}2004/dosformattedfiles/mailminder/php_mm/

801 2005-10-20 05:12:18 mailminder_{—}2004/dosformattedfiles/mailminder/php_mm/authentication.php

814 2005-10-20 05:12:18 mailminder_{—}2004/dosformattedfiles/mailminder/php_mm/buy_service_response.php

77 2005-10-20 05:12:18 mailminder_{—}2004/dosformattedfiles/mailminder/php_mm/cron_mm_lindows.txt

60 2005-10-20 05:12:18 mailminder_{—}2004/dosformattedfiles/mailminder/php_mm/cron_mm_sti.txt

0 2005-10-20 05:12:18 mailminder_{—}2004/dosformattedfiles/mailminder/php_mm/cvs/

846 2005-10-20 05:12:18 mailminder_{—}2004/dosformattedfiles/mailminder/php_mm/cvs/Entries

35 2005-10-20 05:12:18 mailminder_{—}2004/dosformattedfiles/mailminder/php_mm/cvs/Repository

26 2005-10-20 05:12:18 mailminder_{—}2004/dosformattedfiles/mailminder/php_mm/cvs/Root

6339 2005-10-20 05:12:18 mailminder_{—}2004/dosformattedfiles/mailminder/php_mm/findmsg.php

541 2005-10-20 05:12:18 mailminder_{—}2004/dosformattedfiles/mailminder/php_mm/log_in_response.php

0 2005-10-20 05:12:18 mailminder_{—}2004/dosformattedfiles/mailminder/php_mm/Mail/

0 2005-10-20 05:12:18 mailminder_{—}2004/dosformattedfiles/mailminder/php_mm/Mail/cvs/

408 2005-10-20 05:12:18 mailminder_{—}2004/dosformattedfiles/mailminder/php_mm/Mail/cvs/Entries

40 2005-10-20 05:12:18 mailminder_{—}2004/dosformattedfiles/mailminder/php_mm/Mail/cvs/Repository

26 2005-10-20 05:12:18 mailminder_{—}2004/dosformattedfiles/mailminder/php_mm/Mail/cvs/Root

7654 2005-10-20 05:12:18 mailminder_{—}2004/dosformattedfiles/mailminder/php_mm/Mail/Mail.php

7665 2005-10-20 05:12:18 mailminder_{—}2004/dosformattedfiles/mailminder/php_mm/Mail/MailMinder.inc

7840 2005-10-20 05:12:18 mailminder_{—}2004/dosformattedfiles/mailminder/php_mm/Mail/MailMinderTEST.inc

24387 2005-10-20 05:12:18 mailminder_{—}2004/dosformattedfiles/mailminder/php_mm/Mail/mime.php

34499 2005-10-20 05:12:18 mailminder_{—}2004/dosformattedfiles/mailminder/php_mm/Mail/mimeDecode.php

13264 2005-10-20 05:12:18 mailminder_{—}2004/dosformattedfiles/mailminder/php_mm/Mail/mimePart.php

29487 2005-10-20 05:12:18 mailminder_{—}2004/dosformattedfiles/mailminder/php_mm/Mail/PEAR.php

32289 2005-10-20 05:12:18 mailminder_{—}2004/dosformattedfiles/mailminder/php_mm/Mail/RFC822.php

3112 2005-10-20 05:12:18 mailminder_{—}2004/dosformattedfiles/mailminder/php_mm/Mail/SendMail.php

8690 2005-10-20 05:12:18 mailminder_{—}2004/dosformattedfiles/mailminder/php_mm/Mail/smtpMail.php

3318 2005-10-20 05:12:18 mailminder_{—}2004/dosformattedfiles/mailminder/php_mm/mailCheck.php

1250 2005-10-20 05:12:18 mailminder_{—}2004/dosformattedfiles/mailminder/php_mm/MailMinder.sql

626 2005-10-20 05:12:18 mailminder_{—}2004/dosformattedfiles/mailminder/php_mm/mm_login.php

5983 2005-10-20 05:12:18 mailminder_{—}2004/dosformattedfiles/mailminder/php_mm/previewmsg.php

793 2005-10-20 05:12:18 mailminder_{—}2004/dosformattedfiles/mailminder/php_mm/removemsg.php

2733 2005-10-20 05:12:18 mailminder_{—}2004/dosformattedfiles/mailminder/php_mm/retmsg.php

3141 2005-10-20 05:12:18 mailminder_{—}2004/dosformattedfiles/mailminder/php_mm/sendnowrequest.php

3189 2005-10-20 05:12:18 mailminder_{—}2004/dosformattedfiles/mailminder/php_mm/sendnowrequest_test.php

2253 2005-10-20 05:12:18 mailminder_{—}2004/dosformattedfiles/mailminder/php_mm/textgetmail.php

6403 2005-10-20 05:12:18 mailminder_{—}2004/dosformattedfiles/mailminder/php_mm/xmlMailpro.php

0 2005-10-20 05:12:18 mailminder_{—}2005/

0 2005-10-20 05:12:18 mailminder_{—}2005/code/

5738 2005-10-20 05:12:18 mailminder_{—}2005/code/jar.mn

0 2005-10-20 05:12:18 mailminder_{—}2005/code/misc/

440 2005-10-20 05:12:18 mailminder_{—}2005/code/misc/all.entries

128 2005-10-20 05:12:18 mailminder_{—}2005/code/misc/installed-chrome.txt

0 2005-10-20 05:12:22 mailminder_{—}2005/code/resources/

0 2005-10-20 05:12:20 mailminder_{—}2005/code/resources/skin/

553 2005-10-20 05:12:18 mailminder_{—}2005/code/resources/skin/contents.rdf

2450 2005-10-20 05:12:18 mailminder_{—}2005/code/resources/skin/datepicker.css

3316 2005-10-20 05:12:18 mailminder_{—}2005/code/resources/skin/mailminder.css

0 2005-10-20 05:12:20 mailminder_{—}2005/code/resources/skin/images/

1021 2005-10-20 05:12:18 mailminder_{—}2005/code/resources/skin/images/calendar.gif

215 2005-10-20 05:12:18 mailminder_{—}2005/code/resources/skin/images/da.png

187 2005-10-20 05:12:20 mailminder_{—}2005/code/resources/skin/images/la.png

198 2005-10-20 05:12:20 mailminder_{—}2005/code/resources/skin/images/lda.png

674 2005-10-20 05:12:20 mailminder_{—}2005/code/resources/skin/images/mm-calmback-disabled.png

839 2005-10-20 05:12:20 mailminder_{—}2005/code/resources/skin/images/mm-calmback-hover.png

816 2005-10-20 05:12:20 mailminder_{—}2005/code/resources/skin/images/mm-calmback.png

692 2005-10-20 05:12:20 mailminder_{—}2005/code/resources/skin/images/mm-calmfwd-disabled.png

859 2005-10-20 05:12:20 mailminder_{—}2005/code/resources/skin/images/mm-calmfwd-hover.png

830 2005-10-20 05:12:20 mailminder_{—}2005/code/resources/skin/images/mm-calmfwd.png

743 2005-10-20 05:12:20 mailminder_{—}2005/code/resources/skin/images/mm-caltoday-hover.png

696 2005-10-20 05:12:20 mailminder_{—}2005/code/resources/skin/images/mm-caltoday.png

596 2005-10-20 05:12:20 mailminder_{—}2005/code/resources/skin/images/mm-calyback-disabled.png

648 2005-10-20 05:12:20 mailminder_{—}2005/code/resources/skin/images/mm-calyback-hover.png

637 2005-10-20 05:12:20 mailminder_{—}2005/code/resources/skin/images/mm-calyback.png

586 2005-10-20 05:12:20 mailminder_{—}2005/code/resources/skin/images/mm-calyfwd-disabled.png

668 2005-10-20 05:12:20 mailminder_{—}2005/code/resources/skin/images/mm-calyfwd-hover.png

664 2005-10-20 05:12:20 mailminder_{—}2005/code/resources/skin/images/mm-calyfwd.png

323 2005-10-20 05:12:20 mailminder_{—}2005/code/resources/skin/images/mm-downarrow-disabled.png

347 2005-10-20 05:12:20 mailminder_{—}2005/code/resources/skin/images/mm-downarrow-hover.png

340 2005-10-20 05:12:20 mailminder_{—}2005/code/resources/skin/images/mm-downarrow.png

477 2005-10-20 05:12:20 mailminder_{—}2005/code/resources/skin/images/mm-hidoptions-hover.png

475 2005-10-20 05:12:20 mailminder_{—}2005/code/resources/skin/images/mm-hidoptions.png

461 2005-10-20 05:12:20 mailminder_{—}2005/code/resources/skin/images/mm-showoptions-hover.png

466 2005-10-20 05:12:20 mailminder_{—}2005/code/resources/skin/images/mm-showoptions.png

327 2005-10-20 05:12:20 mailminder_{—}2005/code/resources/skin/images/mm-uparrow-disabled.png

341 2005-10-20 05:12:20 mailminder_{—}2005/code/resources/skin/images/mm-uparrow-hover.png

332 2005-10-20 05:12:20 mailminder_{—}2005/code/resources/skin/images/mm-uparrow.png

186 2005-10-20 05:12:20 mailminder_{—}2005/code/resources/skin/images/ra.png

200 2005-10-20 05:12:20 mailminder_{—}2005/code/resources/skin/images/rda.png

204 2005-10-20 05:12:20 mailminder_{—}2005/code/resources/skin/images/ua.png

0 2005-10-20 05:12:20 mailminder_{—}2005/code/resources/skin/icons/

12537 2005-10-20 05:12:20 mailminder_{—}2005/code/resources/skin/icons/mailminder-128.png

505 2005-10-20 05:12:20 mailminder_{—}2005/code/resources/skin/icons/mailminder-16.png

3962 2005-10-20 05:12:20 mailminder_{—}2005/code/resources/skin/icons/mailminder-22.png

3332 2005-10-20 05:12:20 mailminder_{—}2005/code/resources/skin/icons/mailminder-48.png

4930 2005-10-20 05:12:20 mailminder_{—}2005/code/resources/skin/icons/mailminder-64.png

0 2005-10-20 05:12:20 mailminder_{—}2005/code/resources/locale/

0 2005-10-20 05:12:20 mailminder_{—}2005/code/resources/locale/en-US/

1377 2005-10-20 05:12:20 mailminder_{—}2005/code/resources/locale/en-US/configure.dtd

1129 2005-10-20 05:12:20 mailminder_{—}2005/code/resources/locale/en-US/contents.rdf

866 2005-10-20 05:12:20 mailminder_{—}2005/code/resources/locale/en-US/datepicker.dtd

743 2005-10-20 05:12:20 mailminder_{—}2005/code/resources/locale/en-US/insertAddresses.dtd

293 2005-10-20 05:12:20 mailminder_{—}2005/code/resources/locale/en-US/loginDialog.dtd

473 2005-10-20 05:12:20 mailminder_{—}2005/code/resources/locale/en-US/mailminder.dtd

6645 2005-10-20 05:12:20 mailminder_{—}2005/code/resources/locale/en-US/mailminder.properties

50 2005-10-20 05:12:20 mailminder_{—}2005/code/resources/locale/en-US/pickers.dtd

247 2005-10-20 05:12:20 mailminder_{—}2005/code/resources/locale/en-US/progressDialog.dtd

1916 2005-10-20 05:12:20 mailminder_{—}2005/code/resources/locale/en-US/winActivateDeactivate.dtd

558 2005-10-20 05:12:20 mailminder_{—}2005/code/resources/locale/en-US/winInsert.dtd

216 2005-10-20 05:12:20 mailminder_{—}2005/code/resources/locale/en-US/winPreviewMsg.dtd

1966 2005-10-20 05:12:20 mailminder_{—}2005/code/resources/locale/en-US/winRetrieveRemove.dtd

0 2005-10-20 05:12:22 mailminder_{—}2005/code/resources/content/

3694 2005-10-20 05:12:22 mailminder_{—}2005/code/resources/content/configure.js

2573 2005-10-20 05:12:22 mailminder_{—}2005/code/resources/content/configure.xul

1022 2005-10-20 05:12:22 mailminder_{—}2005/code/resources/content/contents.rdf

1029 2005-10-20 05:12:22 mailminder_{—}2005/code/resources/content/contents.rdf.in

10473 2005-10-20 05:12:22 mailminder_{—}2005/code/resources/content/datepicker.xul

9605 2005-10-20 05:12:22 mailminder_{—}2005/code/resources/content/insertAddresses.js

2657 2005-10-20 05:12:22 mailminder_{—}2005/code/resources/content/insertAddresses.xul

3574 2005-10-20 05:12:22 mailminder_{—}2005/code/resources/content/loginDialog.js

1179 2005-10-20 05:12:22 mailminder_{—}2005/code/resources/content/loginDialog.xul

13382 2005-10-20 05:12:22 mailminder_{—}2005/code/resources/content/mailminder-shared.js

6400 2005-10-20 05:12:22 mailminder_{—}2005/code/resources/content/mailminder.js

2768 2005-10-20 05:12:22 mailminder_{—}2005/code/resources/content/mailminderOverlay.xul

6660 2005-10-20 05:12:22 mailminder_{—}2005/code/resources/content/pickers.xml

636 2005-10-20 05:12:22 mailminder_{—}2005/code/resources/content/progressDialog.js

937 2005-10-20 05:12:22 mailminder_{—}2005/code/resources/content/progressDialog.xul

30235 2005-10-20 05:12:22 mailminder_{—}2005/code/resources/content/winActivateDeactivate.js

6334 2005-10-20 05:12:22 mailminder_{—}2005/code/resources/content/winActivateDeactivate.xul

5414 2005-10-20 05:12:22 mailminder_{—}2005/code/resources/content/winInsert.js

2433 2005-10-20 05:12:22 mailminder_{—}2005/code/resources/content/winInsert.xul

4852 2005-10-20 05:12:22 mailminder_{—}2005/code/resources/content/winPreviewMsg.js

2217 2005-10-20 05:12:22 mailminder_{—}2005/code/resources/content/winPreviewMsg.xul

23589 2005-10-20 05:12:22 mailminder_{—}2005/code/resources/content/winRetrieveRemove.js

11929 2005-10-20 05:12:22 mailminder_{—}2005/code/resources/content/winRetrieveRemove.xul

0 2005-10-20 05:12:22 mailminder_{—}2005/code/resources/content/html/

419 2005-10-20 05:12:22 mailminder_{—}2005/code/resources/content/html/index.html

504 2005-10-20 05:12:22 mailminder_{—}2005/code/resources/content/html/previewError.html

0 2005-10-20 05:40:56 mailminder_{—}2005/dosformattedfiles/

0 2005-10-20 05:41:12 mailminder_{—}2005/dosformattedfiles/misc/

126 2005-10-20 05:43:34 mailminder_{—}2005/dosformattedfiles/misc/installed-chrome.txt

438 2005-10-20 05:43:18 mailminder_{—}2005/dosformattedfiles/misc/all.entries

0 2005-10-20 05:41:12 mailminder_{—}2005/dosformattedfiles/resources/

0 2005-10-20 05:41:12 mailminder_{—}2005/dosformattedfiles/resources/content/

3692 2005-10-20 05:44:04 mailminder_{—}2005/dosformattedfiles/resources/content/configure.js

2571 2005-10-20 05:44:18 mailminder_{—}2005/dosformattedfiles/resources/content/configure.xul

10471 2005-10-20 05:45:04 mailminder_{—}2005/dosformattedfiles/resources/content/datepicker.xul

9603 2005-10-20 05:45:16 mailminder_{—}2005/dosformattedfiles/resources/content/insertAddresses.js

2655 2005-10-20 05:45:30 mailminder_{—}2005/dosformattedfiles/resources/content/insertAddresses.xul

3572 2005-10-20 05:45:52 mailminder_{—}2005/dosformattedfiles/resources/content/loginDialog.js

1177 2005-10-20 05:46:02 mailminder_{—}2005/dosformattedfiles/resources/content/loginDialog.xul

13380 2005-10-20 05:46:28 mailminder_{—}2005/dosformattedfiles/resources/content/mailminder-shared.js

6398 2005-10-20 05:46:10 mailminder_{—}2005/dosformattedfiles/resources/content/mailminder.js

2766 2005-10-20 05:46:20 mailminder_{—}2005/dosformattedfiles/resources/content/mailminderOverlay.xul

6658 2005-10-20 05:46:36 mailminder_{—}2005/dosformattedfiles/resources/content/pickers.xml

634 2005-10-20 05:46:44 mailminder_{—}2005/dosformattedfiles/resources/content/progressDialog.js

935 2005-10-20 05:46:58 mailminder_{—}2005/dosformattedfiles/resources/content/progressDialog.xul

30234 2005-10-20 05:47:06 mailminder_{—}2005/dosformattedfiles/resources/content/winActivateDeactivate.js

6332 2005-10-20 05:47:14 mailminder_{—}2005/dosformattedfiles/resources/content/winActivateDeactivate.xul

5412 2005-10-20 05:47:22 mailminder_{—}2005/dosformattedfiles/resources/content/winInsert.js

2431 2005-10-20 05:47:30 mailminder_{—}2005/dosformattedfiles/resources/content/winInsert.xul

4850 2005-10-20 05:47:38 mailminder_{—}2005/dosformattedfiles/resources/content/winPreviewMsg.js

2215 2005-10-20 05:47:46 mailminder_{—}2005/dosformattedfiles/resources/content/winPreviewMsg.xul

23587 2005-10-20 05:47:54 mailminder_{—}2005/dosformattedfiles/resources/content/winRetrieveRemove.js

11927 2005-10-20 05:48:14 mailminder_{—}2005/dosformattedfiles/resources/content/winRetrieveRemove.xul

0 2005-10-20 05:41:12 mailminder_{—}2005/dosformattedfiles/resources/content/html/

419 2005-10-20 05:12:22 mailminder_{—}2005/dosformattedfiles/resources/content/html/index.html

504 2005-10-20 05:12:22 mailminder_{—}2005/dosformattedfiles/resources/content/html/previewError.html

1027 2005-10-20 05:44:54 mailminder_{—}2005/dosformattedfiles/resources/content/contents.rdf.in

1020 2005-10-20 05:44:38 mailminder_{—}2005/dosformattedfiles/resources/content/contents.rdf

0 2005-10-20 05:41:12 mailminder_{—}2005/dosformattedfiles/resources/locale/

0 2005-10-20 05:41:12 mailminder_{—}2005/dosformattedfiles/resources/locale/en-US/

1377 2005-10-20 05:12:20 mailminder_{—}2005/dosformattedfiles/resources/locale/en-US/configure.dtd

1129 2005-10-20 05:12:20 mailminder_{—}2005/dosformattedfiles/resources/locale/en-US/contents.rdf

866 2005-10-20 05:12:20 mailminder_{—}2005/dosformattedfiles/resources/locale/en-US/datepicker.dtd

743 2005-10-20 05:12:20 mailminder_{—}2005/dosformattedfiles/resources/locale/en-US/insertAddresses.dtd

293 2005-10-20 05:12:20 mailminder_{—}2005/dosformattedfiles/resources/locale/en-US/loginDialog.dtd

473 2005-10-20 05:12:20 mailminder_{—}2005/dosformattedfiles/resources/locale/en-US/mailminder.dtd

6645 2005-10-20 05:12:20 mailminder_{—}2005/dosformattedfiles/resources/locale/en-US/mailminder.properties

50 2005-10-20 05:12:20 mailminder_{—}2005/dosformattedfiles/resources/locale/en-US/pickers.dtd

247 2005-10-20 05:12:20 mailminder_{—}2005/dosformattedfiles/resources/locale/en-US/progressDialog.dtd

1916 2005-10-20 05:12:20 mailminder_{—}2005/dosformattedfiles/resources/locale/en-US/winActivateDeactivate.dtd

558 2005-10-20 05:12:20 mailminder_{—}2005/dosformattedfiles/resources/locale/en-US/winInsert.dtd

216 2005-10-20 05:12:20 mailminder_{—}2005/dosformattedfiles/resources/locale/en-US/winPreviewMsg.dtd

1966 2005-10-20 05:12:20 mailminder_{—}2005/dosformattedfiles/resources/locale/en-US/winRetrieveRemove.dtd

0 2005-10-20 05:41:12 mailminder_{—}2005/dosformattedfiles/resources/skin/

553 2005-10-20 05:12:18 mailminder_{—}2005/dosformattedfiles/resources/skin/contents.rdf

2450 2005-10-20 05:12:18 mailminder_{—}2005/dosformattedfiles/resources/skin/datepicker.css

3316 2005-10-20 05:12:18 mailminder_{—}2005/dosformattedfiles/resources/skin/mailminder.css

0 2005-10-20 05:41:12 mailminder_{—}2005/dosformattedfiles/resources/skin/icons/

12537 2005-10-20 05:12:20 mailminder_{—}2005/dosformattedfiles/resources/skin/icons/mailminder-128.png

505 2005-10-20 05:12:20 mailminder_{—}2005/dosformattedfiles/resources/skin/icons/mailminder-16.png

3962 2005-10-20 05:12:20 mailminder_{—}2005/dosformattedfiles/resources/skin/icons/mailminder-22.png

3332 2005-10-20 05:12:20 mailminder_{—}2005/dosformattedfiles/resources/skin/icons/mailminder-48.png

4930 2005-10-20 05:12:20 mailminder_{—}2005/dosformattedfiles/resources/skin/icons/mailminder-64.png

0 2005-10-20 05:41:12 mailminder_{—}2005/dosformattedfiles/resources/skin/images/

1021 2005-10-20 05:12:18 mailminder_{—}2005/dosformattedfiles/resources/skin/images/calendar.gif

215 2005-10-20 05:12:18 mailminder_{—}2005/dosformattedfiles/resources/skin/images/da.png

187 2005-10-20 05:12:20 mailminder_{—}2005/dosformattedfiles/resources/skin/images/la.png

198 2005-10-20 05:12:20 mailminder_{—}2005/dosformattedfiles/resources/skin/images/lda.png

674 2005-10-20 05:12:20 mailminder_{—}2005/dosformattedfiles/resources/skin/images/mm-calmback-disabled.png

839 2005-10-20 05:12:20 mailminder_{—}2005/dosformattedfiles/resources/skin/images/mm-calmback-hover.png

816 2005-10-20 05:12:20 mailminder_{—}2005/dosformattedfiles/resources/skin/images/mm-calmback.png

692 2005-10-20 05:12:20 mailminder_{—}2005/dosformattedfiles/resources/skin/images/mm-calmfwd-disabled.png

859 2005-10-20 05:12:20 mailminder_{—}2005/dosformattedfiles/resources/skin/images/mm-calmfwd-hover.png

830 2005-10-20 05:12:20 mailminder_{—}2005/dosformattedfiles/resources/skin/images/mm-calmfwd.png

743 2005-10-20 05:12:20 mailminder_{—}2005/dosformattedfiles/resources/skin/images/mm-caltoday-hover.png

696 2005-10-20 05:12:20 mailminder_{—}2005/dosformattedfiles/resources/skin/images/mm-caltoday.png

596 2005-10-20 05:12:20 mailminder_{—}2005/dosformattedfiles/resources/skin/images/mm-calyback-disabled.png

648 2005-10-20 05:12:20 mailminder_{—}2005/dosformattedfiles/resources/skin/images/mm-calyback-hover.png

637 2005-10-20 05:12:20 mailminder_{—}2005/dosformattedfiles/resources/skin/images/mm-calyback.png

586 2005-10-20 05:12:20 mailminder_{—}2005/dosformattedfiles/resources/skin/images/mm-calyfwd-disabled.png

668 2005-10-20 05:12:20 mailminder_{—}2005/dosformattedfiles/resources/skin/images/mm-calyfwd-hover.png

664 2005-10-20 05:12:20 mailminder_{—}2005/dosformattedfiles/resources/skin/images/mm-calyfwd.png

323 2005-10-20 05:12:20 mailminder_{—}2005/dosformattedfiles/resources/skin/images/mm-downarrow-disabled.png

347 2005-10-20 05:12:20 mailminder_{—}2005/dosformattedfiles/resources/skin/images/mm-downarrow-hover.png

340 2005-10-20 05:12:20 mailminder_{—}2005/dosformattedfiles/resources/skin/images/mm-downarrow.png

477 2005-10-20 05:12:20 mailminder_{—}2005/dosformattedfiles/resources/skin/images/mm-hidoptions-hover.png

475 2005-10-20 05:12:20 mailminder_{—}2005/dosformattedfiles/resources/skin/images/mm-hidoptions.png

461 2005-10-20 05:12:20 mailminder_{—}2005/dosformattedfiles/resources/skin/images/mm-showoptions-hover.png

466 2005-10-20 05:12:20 mailminder_{—}2005/dosformattedfiles/resources/skin/images/mm-showoptions.png

327 2005-10-20 05:12:20 mailminder_{—}2005/dosformattedfiles/resources/skin/images/mm-uparrow-disabled.png

341 2005-10-20 05:12:20 mailminder_{—}2005/dosformattedfiles/resources/skin/images/mm-uparrow-hover.png

332 2005-10-20 05:12:20 mailminder_{—}2005/dosformattedfiles/resources/skin/images/mm-uparrow.png

186 2005-10-20 05:12:20 mailminder_{—}2005/dosformattedfiles/resources/skin/images/ra.png

200 2005-10-20 05:12:20 mailminder_{—}2005/dosformattedfiles/resources/skin/images/rda.png

204 2005-10-20 05:12:20 mailminder_{—}2005/dosformattedfiles/resources/skin/images/ua.png

5736 2005-10-20 05:42:34 mailminder_{—}2005/dosformattedfiles/jar.mn

This application is being submitted with two copies of a Computer Program Listing Appendix submitted on a Compact Disc pursuant to 37 CFR 1.52. The appendix is readable using an MS-Windows platform. The following is a list of files and directories contained on each disc, denoted by size in bytes, a date and time of creation in this heirarchy, and a directory or file name:

0 2005-10-20 05:12:12 mailminder_{—}2004/

0 2005-10-20 05:12:10 mailminder_{—}2004/code/

0 2005-10-20 05:12:02 mailminder_{—}2004/code/los_source/

0 2005-10-20 05:12:10 mailminder_{—}2004/code/los_source/mailminder/

0 2005-10-20 05:12:02 mailminder_{—}2004/code/los_source/mailminder/base/

0 2005-10-20 05:12:02 mailminder_{—}2004/code/los_source/mailminder/base/cvs/

164 2005-10-20 05:12:02 mailminder_{—}2004/code/los_source/mailminder/base/cvs/Entries

35 2005-10-20 05:12:02 mailminder_{—}2004/code/los_source/mailminder/base/cvs/Repository

41 2005-10-20 05:12:02 mailminder_{—}2004/code/los_source/mailminder/base/cvs/Root

24 2005-10-20 05:12:02 mailminder_{—}2004/code/los_source/mailminder/base/cvs/Tag

2051 2005-10-20 05:12:02 mailminder_{—}2004/code/los_source/mailminder/base/Makefile

2069 2005-10-20 05:12:02 mailminder_{—}2004/code/los_source/mailminder/base/Makefile.in

0 2005-10-20 05:12:02 mailminder_{—}2004/code/los_source/mailminder/base/public/

0 2005-10-20 05:12:02 mailminder_{—}2004/code/los_source/mailminder/base/public/cvs/

225 2005-10-20 05:12:02 mailminder_{—}2004/code/los_source/mailminder/base/public/cvs/Entries

42 2005-10-20 05:12:02 mailminder_{—}2004/code/los_source/mailminder/base/public/cvs/Repository

41 2005-10-20 05:12:02 mailminder_{—}2004/code/los_source/mailminder/base/public/cvs/Root

24 2005-10-20 05:12:02 mailminder_{—}2004/code/los_source/mailminder/base/public/cvs/Tag

1834 2005-10-20 05:12:02 mailminder_{—}2004/code/los_source/mailminder/base/public/Makefile

1849 2005-10-20 05:12:02 mailminder_{—}2004/code/los_source/mailminder/base/public/Makefile.in

2171 2005-10-2005:12:02 mailminder_{—}2004/code/los_source/mailminder/base/public/mozIMailminder.idl

0 2005-10-20 05:12:02 mailminder_{—}2004/code/los_source/mailminder/base/src/

0 2005-10-20 05:12:02 mailminder_{—}2004/code/los_source/mailminder/base/src/cvs/

303 2005-10-20 05:12:02 mailminder_{—}2004/code/los_source/mailminder/base/src/cvs/Entries

39 2005-10-20 05:12:02 mailminder_{—}2004/code/los_source/mailminder/base/src/cvs/Repository

41 2005-10-20 05:12:02 mailminder_{—}2004/code/los_source/mailminder/base/src/cvs/Root

24 2005-10-20 05:12:02 mailminder_{—}2004/code/los_source/mailminder/base/src/cvs/Tag

1894 2005-10-20 05:12:02 mailminder_{—}2004/code/los_source/mailminder/base/src/Makefile

1909 2005-10-20 05:12:02 mailminder_{—}2004/code/los_source/mailminder/base/src/Makefile.in

2250 2005-10-20 05:12:02 mailminder_{—}2004/code/los_source/mailminder/base/src/mozMailminder.cpp

277 2005-10-20 05:12:02 mailminder_{—}2004/code/los_source/mailminder/base/src/mozMailminder.h

0 2005-10-20 05:12:04 mailminder_{—}2004/code/los_source/mailminder/build/

0 2005-10-20 05:12:04 mailminder_{—}2004/code/los_source/mailminder/build/cvs/

151 2005-10-20 05:12:02 mailminder_{—}2004/code/los_source/mailminder/build/cvs/Entries

36 2005-10-20 05:12:04 mailminder_{—}2004/code/los_source/mailminder/build/cvs/Repository

41 2005-10-20 05:12:04 mailminder_{—}2004/code/los_source/mailminder/build/cvs/Root

24 2005-10-20 05:12:04 mailminder_{—}2004/code/los_source/mailminder/build/cvs/Tag

2044 2005-10-20 05:12:04 mailminder_{—}2004/code/los_source/mailminder/build/Makefile

2062 2005-10-20 05:12:04 mailminder_{—}2004/code/los_source/mailminder/build/Makefile.in

0 2005-10-20 05:12:04 mailminder_{—}2004/code/los_source/mailminder/build/src/

0 2005-10-20 05:12:04 mailminder_{—}2004/code/los_source/mailminder/build/src/cvs/

234 2005-10-20 05:12:04 mailminder_{—}2004/code/los_source/mailminder/build/src/cvs/Entries

40 2005-10-20 05:12:04 mailminder_{—}2004/code/los_source/mailminder/build/src/cvs/Repository

41 2005-10-20 05:12:04 mailminder_{—}2004/code/los_source/mailminder/build/src/cvs/Root

24 2005-10-20 05:12:04 mailminder_{—}2004/code/los_source/mailminder/build/src/cvs/Tag

2220 2005-10-20 05:12:04 mailminder_{—}2004/code/los_source/mailminder/build/src/Makefile

2235 2005-10-20 05:12:04 mailminder_{—}2004/code/los_source/mailminder/build/src/Makefile.in

2198 2005-10-20 05:12:04 mailminder_{—}2004/code/los_source/mailminder/build/src/mozMailminderModule.cpp

0 2005-10-20 05:12:04 mailminder_{—}2004/code/los_source/mailminder/cvs/

417 2005-10-20 05:12:04 mailminder_{—}2004/code/los_source/mailminder/cvs/Entries

30 2005-10-20 05:12:04 mailminder_{—}2004/code/los_source/mailminder/cvs/Repository

41 2005-10-20 05:12:04 mailminder_{—}2004/code/los_source/mailminder/cvs/Root

24 2005-10-20 05:12:04 mailminder_{—}2004/code/los_source/mailminder/cvs/Tag

5672 2005-10-20 05:12:04 mailminder_{—}2004/code/los_source/mailminder/jar.mn

2434 2005-10-20 05:12:04 mailminder_{—}2004/code/los_source/mailminder/Makefile.in

0 2005-10-20 05:12:04 mailminder_{—}2004/code/los_source/mailminder/misc/

431 2005-10-20 05:12:04 mailminder_{—}2004/code/los_source/mailminder/misc/all.entries

0 2005-10-20 05:12:04 mailminder_{—}2004/code/los_source/mailminder/misc/cvs/

153 2005-10-20 05:12:04 mailminder_{—}2004/code/los_source/mailminder/misc/cvs/Entries

35 2005-10-20 05:12:04 mailminder_{—}2004/code/los_source/mailminder/misc/cvs/Repository

41 2005-10-20 05:12:04 mailminder_{—}2004/code/los_source/mailminder/misc/cvs/Root

24 2005-10-20 05:12:04 mailminder_{—}2004/code/los_source/mailminder/misc/cvs/Tag

126 2005-10-20 05:12:04 mailminder_{—}2004/code/los_source/mailminder/misc/installed-chrome.txt

1770 2005-10-20 05:12:04 mailminder_{—}2004/code/los_source/mailminder/readme

0 2005-10-20 05:12:06 mailminder_{—}2004/code/los_source/mailminder/resources/

0 2005-10-20 05:12:06 mailminder_{—}2004/code/los_source/mailminder/resources/content/

3543 2005-10-20 05:12:04 mailminder_{—}2004/code/los_source/mailminder/resources/content/configure.js

2509 2005-10-20 05:12:04 mailminder_{—}2004/code/los_source/mailminder/resources/content/configure.xul

995 2005-10-20 05:12:04 mailminder_{—}2004/code/los_source/mailminder/resources/content/contents.rdf

1002 2005-10-20 05:12:04 mailminder_{—}2004/code/los_source/mailminder/resources/content/contents.rdf.in

0 2005-10-20 05:12:04 mailminder_{—}2004/code/los_source/mailminder/resources/content/cvs/

1852 2005-10-20 05:12:04 mailminder_{—}2004/code/los_source/mailminder/resources/content/cvs/Entries

48 2005-10-20 05:12:04 mailminder_{—}2004/code/los_source/mailminder/resources/content/cvs/Repository

41 2005-10-20 05:12:04 mailminder_{—}2004/code/los_source/mailminder/resources/content/cvs/Root

24 2005-10-20 05:12:04 mailminder_{—}2004/code/los_source/mailminder/resources/content/cvs/Tag

10086 2005-10-20 05:12:04 mailminder_{—}2004/code/los_source/mailminder/resources/content/datepicker.xul

0 2005-10-20 05:12:04 mailminder_{—}2004/code/los_source/mailminder/resources/content/html/

0 2005-10-20 05:12:04 mailminder_{—}2004/code/los_source/mailminder/resources/content/html/cvs/

149 2005-10-20 05:12:04 mailminder_{—}2004/code/los_source/mailminder/resources/content/html/cvs/Entries

53 2005-10-20 05:12:04 mailminder_{—}2004/code/los_source/mailminder/resources/content/html/cvs/Repository

41 2005-10-20 05:12:04 mailminder_{—}2004/code/los_source/mailminder/resources/content/html/cvs/Root

24 2005-10-20 05:12:04 mailminder_{—}2004/code/los_source/mailminder/resources/content/html/cvs/Tag

401 2005-10-20 05:12:04 mailminder_{—}2004/code/los_source/mailminder/resources/content/html/index.html

483 2005-10-20 05:12:04 mailminder_{—}2004/code/los_source/mailminder/resources/content/html/previewError.html

9204 2005-10-20 05:12:04 mailminder_{—}2004/code/los_source/mailminder/resources/content/insertAddresses.js

2589 2005-10-20 05:12:04 mailminder_{—}2004/code/los_source/mailminder/resources/content/insertAddresses.xul

3373 2005-10-20 05:12:04 mailminder_{—}2004/code/los_source/mailminder/resources/content/loginDialog.js

1042 2005-10-20 05:12:06 mailminder_{—}2004/code/los_source/mailminder/resources/content/loginDialog.xul

5053 2005-10-20 05:12:06 mailminder_{—}2004/code/los_source/mailminder/resources/content/mailminder.js

2697 2005-10-20 05:12:06 mailminder_{—}2004/code/los_source/mailminder/resources/content/mailminderOverlay.xul

11463 2005-10-20 05:12:06 mailminder_{—}2004/code/los_source/mailminder/resources/content/mailminder-shared.js

6444 2005-10-20 05:12:06 mailminder_{—}2004/code/los_source/mailminder/resources/content/pickers.xml

598 2005-10-20 05:12:06 mailminder_{—}2004/code/los_source/mailminder/resources/content/progressDialog.js

934 2005-10-20 05:12:06 mailminder_{—}2004/code/los_source/mailminder/resources/content/progressDialog.xul

25702 2005-10-20 05:12:06 mailminder_{—}2004/code/los_source/mailminder/resources/content/winActivateDeactivate.js

4400 2005-10-20 05:12:06 mailminder_{—}2004/code/los_source/mailminder/resources/content/winActivateDeactivate.xul

5222 2005-10-20 05:12:06 mailminder_{—}2004/code/los_source/mailminder/resources/content/winInsert.js

2368 2005-10-20 05:12:06 mailminder_{—}2004/code/los_source/mailminder/resources/content/winInsert.xul

4658 2005-10-20 05:12:06 mailminder_{—}2004/code/los_source/mailminder/resources/content/winPreviewMsg.js

2151 2005-10-20 05:12:06 mailminder_{—}2004/code/los_source/mailminder/resources/content/winPreviewMsg.xul

23019 2005-10-20 05:12:06 mailminder_{—}2004/code/los_source/mailminder/resources/content/winRetrieveRemove.js

11660 2005-10-20 05:12:06 mailminder_{—}2004/code/los_source/mailminder/resources/content/winRetrieveRemove.xul

0 2005-10-20 05:12:06 mailminder_{—}2004/code/los_source/mailminder/resources/cvs/

179 2005-10-20 05:12:06 mailminder_{—}2004/code/los_source/mailminder/resources/cvs/Entries

40 2005-10-20 05:12:06 mailminder_{—}2004/code/los_source/mailminder/resources/cvs/Repository

41 2005-10-20 05:12:06 mailminder_{—}2004/code/los_source/mailminder/resources/cvs/Root

24 2005-10-20 05:12:06 mailminder_{—}2004/code/los_source/mailminder/resources/cvs/Tag

0 2005-10-20 05:12:06 mailminder_{—}2004/code/los_source/mailminder/resources/locale/

0 2005-10-20 05:12:06 mailminder_{—}2004/code/los_source/mailminder/resources/locale/cvs/

12 2005-10-20 05:12:06 mailminder_{—}2004/code/los_source/mailminder/resources/locale/cvs/Entries

47 2005-10-20 05:12:06 mailminder_{—}2004/code/los_source/mailminder/resources/locale/cvs/Repository

41 2005-10-20 05:12:06 mailminder_{—}2004/code/los_source/mailminder/resources/locale/cvs/Root

24 2005-10-20 05:12:06 mailminder_{—}2004/code/los_source/mailminder/resources/locale/cvs/Tag

0 2005-10-20 05:12:06 mailminder_{—}2004/code/los_source/mailminder/resources/locale/en-US/

1355 2005-10-20 05:12:06 mailminder_{—}2004/code/los_source/mailminder/resources/locale/en-US/configure.dtd

1105 2005-10-20 05:12:06 mailminder_{—}2004/code/los_source/mailminder/resources/locale/en-US/contents.rdf

0 2005-10-20 05:12:06 mailminder 2004/code/los_source/mailminder/resources/locale/en-US/cvs/

1028 2005-10-20 05:12:06 mailminder_{—}2004/code/los_source/mailminder/resources/locale/en-US/cvs/Entries

53 2005-10-20 05:12:06 mailminder_{—}2004/code/los_source/mailminder/resources/locale/en-US/cvs/Repository

41 2005-10-20 05:12:06 mailminder_{—}2004/code/los_source/mailminder/resources/locale/en-US/cvs/Root

24 2005-10-20 05:12:06 mailminder_{—}2004/code/los_source/mailminder/resources/locale/en-US/cvs/Tag

838 2005-10-20 05:12:06 mailminder_{—}2004/code/los_source/mailminder/resources/locale/en-US/datepicker.dtd

727 2005-10-20 05:12:06 mailminder_{—}2004/code/los_source/mailminder/resources/locale/en-US/insertAddresses.dtd

286 2005-10-20 05:12:06 mailminder_{—}2004/code/los_source/mailminder/resources/locale/en-US/loginDialog.dtd

462 2005-10-20 05:12:06 mailminder_{—}2004/code/los_source/mailminder/resources/locale/en-US/mailminder.dtd

6024 2005-10-20 05:12:06 mailminder_{—}2004/code/los_source/mailminder/resources/locale/en-US/mailminder.properties

48 2005-10-20 05:12:06 mailminder_{—}2004/code/los_source/mailminder/resources/locale/en-US/pickers.dtd

242 2005-10-20 05:12:06 mailminder_{—}2004/code/los_source/mailminder/resources/locale/en-US/progressDialog.dtd

1465 2005-10-20 05:12:06 mailminder_{—}2004/code/los_source/mailminder/resources/locale/en-US/winActivateDeactivate.dtd

546 2005-10-20 05:12:06 mailminder_{—}2004/code/los_source/mailminder/resources/locale/en-US/winInsert.dtd

212 2005-10-20 05:12:06 mailminder_{—}2004/code/los_source/mailminder/resources/locale/en-US/winPreviewMsg.dtd

1924 2005-10-20 05:12:06 mailminder_{—}2004/code/los_source/mailminder/resources/locale/en-US/winRetrieveRemove.dtd

1762 2005-10-20 05:12:06 mailminder_{—}2004/code/los_source/mailminder/resources/Makefile

1780 2005-10-20 05:12:06 mailminder_{—}2004/code/los_source/mailminder/resources/Makefile.in

0 2005-10-20 05:12:08 mailminder_{—}2004/code/los_source/mailminder/resources/skin/

539 2005-10-20 05:12:06 mailminder_{—}2004/code/los_source/mailminder/resources/skin/contents.rdf

0 2005-10-20 05:12:06 mailminder_{—}2004/code/los_source/mailminder/resources/skin/cvs/

254 2005-10-20 05:12:06 mailminder_{—}2004/code/los_source/mailminder/resources/skin/cvs/Entries

45 2005-10-20 05:12:06 mailminder_{—}2004/code/los_source/mailminder/resources/skin/cvs/Repository

41 2005-10-20 05:12:06 mailminder_{—}2004/code/los_source/mailminder/resources/skin/cvs/Root

24 2005-10-20 05:12:06 mailminder_{—}2004/code/los_source/mailminder/resources/skin/cvs/Tag

2301 2005-10-2005:12:08 mailminder_{—}2004/code/los_source/mailminder/resources/skin/datepicker.css

0 2005-10-20 05:12:08 mailminder_{—}2004/code/los_source/mailminder/resources/skin/icons/

0 2005-10-20 05:12:08 mailminder_{—}2004/code/los_source/mailminder/resources/skin/icons/cvs/

403 2005-10-20 05:12:08 mailminder_{—}2004/code/los_source/mailminder/resources/skin/icons/cvs/Entries

51 2005-10-2005:12:08 mailminder_{—}2004/code/los_source/mailminder/resources/skin/icons/cvs/Repository

41 2005-10-2005:12:08 mailminder_{—}2004/code/los_source/mailminder/resources/skin/icons/cvs/Root

24 2005-10-20 05:12:08 mailminder_{—}2004/code/los_source/mailminder/resources/skin/icons/cvs/Tag

12537 2005-10-20 05:12:08 mailminder_{—}2004/code/los_source/mailminder/resources/skin/icons/mailminder-128.png

505 2005-10-20 05:12:08 mailminder_{—}2004/code/los_source/mailminder/resources/skin/icons/mailminder-16.png

3962 2005-10-20 05:12:08 mailminder_{—}2004/code/los_source/mailminder/resources/skin/icons/mailminder-22.png

3332 2005-10-20 05:12:08 mailminder_{—}2004/code/los_source/mailminder/resources/skin/icons/mailminder-48.png

4930 2005-10-20 05:12:08 mailminder_{—}2004/code/los_source/mailminder/resources/skin/icons/mailminder-64.png

0 2005-10-20 05:12:08 mailminder_{—}2004/code/los_source/mailminder/resources/skin/images/

1019 2005-10-20 05:12:08 mailminder_{—}2004/code/los_source/mailminder/resources/skin/images/calendar.gif

0 2005-10-20 05:12:08 mailminder_{—}2004/code/los_source/mailminder/resources/skin/images/cvs/

2468 2005-10-20 05:12:08 mailminder_{—}2004/code/los_source/mailminder/resources/skin/images/cvs/Entries

52 2005-10-20 05:12:08 mailminder_{—}2004/code/los_source/mailminder/resources/skin/images/cvs/Repository

41 2005-10-2005:12:08 mailminder_{—}2004/code/los_source/mailminder/resources/skin/images/cvs/Root

24 2005-10-20 05:12:08 mailminder_{—}2004/code/los_source/mailminder/resources/skin/images/cvs/Tag

212 2005-10-20 05:12:08 mailminder_{—}2004/code/los_source/mailminder/resources/skin/images/da.png

187 2005-10-20 05:12:08 mailminder_{—}2004/code/los_source/mailminder/resources/skin/images/la.png

198 2005-10-20 05:12:08 mailminder_{—}2004/code/los_source/mailminder/resources/skin/images/lda.png

816 2005-10-20 05:12:08 mailminder_{—}2004/code/los_source/mailminder/resources/skin/images/mm-calmback.png

674 2005-10-20 05:12:08 mailminder_{—}2004/code/los_source/mailminder/resources/skin/images/mm-calmback-disabled.png

839 2005-10-20 05:12:08 mailminder_{—}2004/code/los_source/mailminder/resources/skin/images/mm-calmback-hover.png

830 2005-10-20 05:12:08 mailminder_{—}2004/code/los_source/mailminder/resources/skin/images/mm-calmfwd.png

692 2005-10-20 05:12:08 mailminder_{—}2004/code/los_source/mailminder/resources/skin/images/mm-calmfwd-disabled.png

859 2005-10-20 05:12:08 mailminder_{—}2004/code/los_source/mailminder/resources/skin/images/mm-calmfwd-hover.png

696 2005-10-20 05:12:08 mailminder_{—}2004/code/los_source/mailminder/resources/skin/images/mm-caltoday.png

743 2005-10-20 05:12:08 mailminder_{—}2004/code/los_source/mailminder/resources/skin/images/mm-caltoday-hover.png

637 2005-10-20 05:12:08 mailminder_{—}2004/code/los_source/mailminder/resources/skin/images/mm-calyback.png

596 2005-10-20 05:12:08 mailminder_{—}2004/code/los_source/mailminder/resources/skin/images/mm-calyback-disabled.png

648 2005-10-20 05:12:08 mailminder_{—}2004/code/los_source/mailminder/resources/skin/images/mm-calyback-hover.png

664 2005-10-20 05:12:08 mailminder_{—}2004/code/los_source/mailminder/resources/skin/images/mm-calyfwd.png

586 2005-10-20 05:12:08 mailminder_{—}2004/code/los_source/mailminder/resources/skin/images/mm-calyfwd-disabled.png

668 2005-10-20 05:12:08 mailminder_{—}2004/code/los_source/mailminder/resources/skin/images/mm-calyfwd-hover.png

340 2005-10-20 05:12:08 mailminder_{—}2004/code/los_source/mailminder/resources/skin/images/mm-downarrow.png

323 2005-10-20 05:12:08 mailminder_{—}2004/code/los_source/mailminder/resources/skin/images/mm-downarrow-disabled.png

347 2005-10-20 05:12:08 mailminder_{—}2004/code/los_source/mailminder/resources/skin/images/mm-downarrow-hover.png

475 2005-10-20 05:12:08 mailminder_{—}2004/code/los_source/mailminder/resources/skin/images/mm-hidoptions.png

477 2005-10-20 05:12:08 mailminder_{—}2004/code/los_source/mailminder/resources/skin/images/mm-hidoptions-hover.png

466 2005-10-20 05:12:08 mailminder_{—}2004/code/los_source/mailminder/resources/skin/images/mm-showoptions.png

461 2005-10-20 05:12:08 mailminder_{—}2004/code/los_source/mailminder/resources/skin/images/mm-showoptions-hover.png

332 2005-10-20 05:12:08 mailminder_{—}2004/code/los_source/mailminder/resources/skin/images/mm-uparrow.png

327 2005-10-20 05:12:08 mailminder_{—}2004/code/los_source/mailminder/resources/skin/images/mm-uparrow-disabled.png

341 2005-10-20 05:12:08 mailminder_{—}2004/code/los_source/mailminder/resources/skin/images/mm-uparrow-hover.png

186 2005-10-20 05:12:08 mailminder_{—}2004/code/los_source/mailminder/resources/skin/images/ra.png

200 2005-10-20 05:12:08 mailminder_{—}2004/code/los_source/mailminder/resources/skin/images/rda.png

201 2005-10-20 05:12:08 mailminder_{—}2004/code/los_source/mailminder/resources/skin/images/ua.png

2714 2005-10-20 05:12:08 mailminder_{—}2004/code/los_source/mailminder/resources/skin/mailminder.css

0 2005-10-20 05:12:10 mailminder_{—}2004/code/los_source/mailminder/scripts/

436 2005-10-20 05:12:08 mailminder_{—}2004/code/los_source/mailminder/scripts/build_hooks.sh

564 2005-10-20 05:12:10 mailminder_{—}2004/code/los_source/mailminder/scripts/build_xpi.sh

0 2005-10-20 05:12:10 mailminder_{—}2004/code/los_source/mailminder/scripts/cvs/

589 2005-10-20 05:12:10 mailminder_{—}2004/code/los_source/mailminder/scripts/cvs/Entries

38 2005-10-20 05:12:10 mailminder_{—}2004/code/los_source/mailminder/scripts/cvs/Repository

41 2005-10-20 05:12:10 mailminder_{—}2004/code/los_source/mailminder/scripts/cvs/Root

24 2005-10-20 05:12:10 mailminder_{—}2004/code/los_source/mailminder/scripts/cvs/Tag

4180 2005-10-20 05:12:10 mailminder_{—}2004/code/los_source/mailminder/scripts/install.js.in

225 2005-10-20 05:12:10 mailminder_{—}2004/code/los_source/mailminder/scripts/mailminder.js

94 2005-10-20 05:12:10 mailminder_{—}2004/code/los_source/mailminder/scripts/move_xpi.sh

1117 2005-10-20 05:12:10 mailminder_{—}2004/code/los_source/mailminder/scripts/project_init.sh

903 2005-10-20 05:12:10 mailminder_{—}2004/code/los_source/mailminder/scripts/version

5 2005-10-20 05:12:10 mailminder_{—}2004/code/los_source/mailminder/version

0 2005-10-20 05:12:10 mailminder_{—}2004/code/mailminder/

0 2005-10-20 05:12:10 mailminder_{—}2004/code/mailminder/php_mm/

773 2005-10-20 05:12:10 mailminder_{—}2004/code/mailminder/php_mm/authentication.php

787 2005-10-20 05:12:10 mailminder_{—}2004/code/mailminder/php_mm/buy_service_response.php

75 2005-10-20 05:12:10 mailminder_{—}2004/code/mailminder/php_mm/cron_mm_lindows.txt

58 2005-10-20 05:12:10 mailminder_{—}2004/code/mailminder/php_mm/cron_mm_sti.txt

0 2005-10-20 05:12:10 mailminder_{—}2004/code/mailminder/php_mm/cvs/

827 2005-10-20 05:12:10 mailminder_{—}2004/code/mailminder/php_mm/cvs/Entries

33 2005-10-20 05:12:10 mailminder_{—}2004/code/mailminder/php_mm/cvs/Repository

24 2005-10-20 05:12:10 mailminder_{—}2004/code/mailminder/php_mm/cvs/Root

6156 2005-10-20 05:12:10 mailminder_{—}2004/code/mailminder/php_mm/findmsg.php

517 2005-10-20 05:12:10 mailminder_{—}2004/code/mailminder/php_mm/log_in_response.php

0 2005-10-20 05:12:10 mailminder_{—}2004/code/mailminder/php_mm/Mail/

0 2005-10-20 05:12:10 mailminder_{—}2004/code/mailminder/php_mm/Mail/cvs/

397 2005-10-20 05:12:10 mailminder_{—}2004/code/mailminder/php_mm/Mail/cvs/Entries

38 2005-10-20 05:12:10 mailminder_{—}2004/code/mailminder/php_mm/Mail/cvs/Repository

24 2005-10-20 05:12:10 mailminder_{—}2004/code/mailminder/php_mm/Mail/cvs/Root

7460 2005-10-20 05:12:10 mailminder_{—}2004/code/mailminder/php_mm/Mail/Mail.php

7444 2005-10-20 05:12:10 mailminder_{—}2004/code/mailminder/php_mm/Mail/MailMinder.inc

7605 2005-10-20 05:12:10 mailminder_{—}2004/code/mailminder/php_mm/Mail/MailMinderTEST.inc

23734 2005-10-20 05:12:10 mailminder_{—}2004/code/mailminder/php_mm/Mail/mime.php

33585 2005-10-20 05:12:10 mailminder_{—}2004/code/mailminder/php_mm/Mail/mimeDecode.php

12910 2005-10-20 05:12:10 mailminder_{—}2004/code/mailminder/php_mm/Mail/mimePart.php

28559 2005-10-20 05:12:10 mailminder_{—}2004/code/mailminder/php_mm/Mail/PEAR.php

31384 2005-10-20 05:12:10 mailminder_{—}2004/code/mailminder/php_mm/Mail/RFC822.php

3010 2005-10-20 05:12:10 mailminder_{—}2004/code/mailminder/php_mm/Mail/SendMail.php

8371 2005-10-20 05:12:10 mailminder_{—}2004/code/mailminder/php_mm/Mail/smtpMail.php

3215 2005-10-20 05:12:10 mailminder_{—}2004/code/mailminder/php_mm/mailCheck.php

1212 2005-10-20 05:12:10 mailminder_{—}2004/code/mailminder/php_mm/MailMinder.sql

599 2005-10-20 05:12:10 mailminder_{—}2004/code/mailminder/php_mm/mm_login.php

5819 2005-10-20 05:12:10 mailminder_{—}2004/code/mailminder/php_mm/previewmsg.php

758 2005-10-20 05:12:10 mailminder_{—}2004/code/mailminder/php_mm/removemsg.php

2654 2005-10-20 05:12:10 mailminder_{—}2004/code/mailminder/php_mm/retmsg.php

3042 2005-10-20 05:12:10 mailminder_{—}2004/code/mailminder/php_mm/sendnowrequest.php

3087 2005-10-20 05:12:10 mailminder_{—}2004/code/mailminder/php_mm/sendnowrequest_test.php

2172 2005-10-20 05:12:10 mailminder_{—}2004/code/mailminder/php_mm/textgetmail.php

6196 2005-10-20 05:12:10 mailminder_{—}2004/code/mailminder/php_mm/xmlMailpro.php

0 2005-10-20 05:12:18 mailminder_{—}2004/dosformattedfiles/

0 2005-10-20 05:12:12 mailminder_{—}2004/dosformattedfiles/los_source/

0 2005-10-20 05:12:18 mailminder_{—}2004/dosformattedfiles/los_source/mailminder/

0 2005-10-20 05:12:12 mailminder_{—}2004/dosformattedfiles/los_source/mailminder/base/

0 2005-10-20 05:12:12 mailminder_{—}2004/dosformattedfiles/los_source/mailminder/base/cvs/

169 2005-10-20 05:12:12 mailminder_{—}2004/dosformattedfiles/los_source/mailminder/base/cvs/Entries

37 2005-10-20 05:12:12 mailminder_{—}2004/dosformattedfiles/los_source/mailminder/base/cvs/Repository

43 2005-10-20 05:12:12 mailminder_{—}2004/dosformattedfiles/los_source/mailminder/base/cvs/Root

26 2005-10-20 05:12:12 mailminder_{—}2004/dosformattedfiles/los_source/mailminder/base/cvs/Tag

2097 2005-10-20 05:12:12 mailminder_{—}2004/dosformattedfiles/los_source/mailminder/base/Makefile

2115 2005-10-2005:12:12 mailminder_{—}2004/dosformattedfiles/los_source/mailminder/base/Makefile.in

0 2005-10-20 05:12:12 mailminder_{—}2004/dosformattedfiles/los_source/mailminder/base/public/

0 2005-10-20 05:12:12 mailminder_{—}2004/dosformattedfiles/los_source/mailminder/base/public/cvs/

230 2005-10-20 05:12:12 mailminder_{—}2004/dosformattedfiles/los_source/mailminder/base/public/cvs/Entries

44 2005-10-20 05:12:12 mailminder_{—}2004/dosformattedfiles/los_source/mailminder/base/public/cvs/Repository

43 2005-10-20 05:12:12 mailminder_{—}2004/dosformattedfiles/los_source/mailminder/base/public/cvs/Root

26 2005-10-20 05:12:12 mailminder_{—}2004/dosformattedfiles/los_source/mailminder/base/public/cvs/Tag

1884 2005-10-20 05:12:12 mailminder_{—}2004/dosformattedfiles/los_source/mailminder/base/public/Makefile

1899 2005-10-20 05:12:12 mailminder_{—}2004/dosformattedfiles/los_source/mailminder/base/public/Makefile.in

2220 2005-10-20 05:12:12 mailminder_{—}2004/dosformattedfiles/los_source/mailminder/base/public/mozIMailminder.idl

0 2005-10-20 05:12:12 mailminder_{—}2004/dosformattedfiles/los_source/mailminder/base/src/

0 2005-10-20 05:12:12 mailminder_{—}2004/dosformattedfiles/los_source/mailminder/base/src/cvs/

309 2005-10-20 05:12:12 mailminder_{—}2004/dosformattedfiles/los_source/mailminder/base/src/cvs/Entries

41 2005-10-20 05:12:12 mailminder_{—}2004/dosformattedfiles/los_source/mailminder/base/src/cvs/Repository

43 2005-10-20 05:12:12 mailminder_{—}2004/dosformattedfiles/los_source/mailminder/base/src/cvs/Root

26 2005-10-20 05:12:12 mailminder_{—}2004/dosformattedfiles/los_source/mailminder/base/src/cvs/Tag

1951 2005-10-2005:12:12 mailminder_{—}2004/dosformattedfiles/los_source/mailminder/base/src/Makefile

1966 2005-10-20 05:12:12 mailminder_{—}2004/dosformattedfiles/los_source/mailminder/base/src/Makefile.in

2325 2005-10-20 05:12:12 mailminder_{—}2004/dosformattedfiles/los_source/mailminder/base/src/mozMailminder.cpp

302 2005-10-20 05:12:12 mailminder_{—}2004/dosformattedfiles/los_source/mailminder/base/src/mozMailminder.h

0 2005-10-20 05:12:12 mailminder_{—}2004/dosformattedfiles/los_source/mailminder/build/

0 2005-10-20 05:12:12 mailminder_{—}2004/dosformattedfiles/los_source/mailminder/build/cvs/

155 2005-10-20 05:12:12 mailminder_{—}2004/dosformattedfiles/los_source/mailminder/build/cvs/Entries

38 2005-10-20 05:12:12 mailminder_{—}2004/dosformattedfiles/los_source/mailminder/build/cvs/Repository

43 2005-10-20 05:12:12 mailminder_{—}2004/dosformattedfiles/los_source/mailminder/build/cvs/Root

26 2005-10-20 05:12:12 mailminder_{—}2004/dosformattedfiles/los_source/mailminder/build/cvs/Tag

2090 2005-10-20 05:12:12 mailminder_{—}2004/dosformattedfiles/los_source/mailminder/build/Makefile

2108 2005-10-20 05:12:12 mailminder_{—}2004/dosformattedfiles/los_source/mailminder/build/Makefile.in

0 2005-10-20 05:12:12 mailminder_{—}2004/dosformattedfiles/los_source/mailminder/build/src/

0 2005-10-20 05:12:12 mailminder_{—}2004/dosformattedfiles/los_source/mailminder/build/src/cvs/

239 2005-10-20 05:12:12 mailminder_{—}2004/dosformattedfiles/los_source/mailminder/build/src/cvs/Entries

42 2005-10-20 05:12:12 mailminder_{—}2004/dosformattedfiles/los_source/mailminder/build/src/cvs/Repository

43 2005-10-20 05:12:12 mailminder_{—}2004/dosformattedfiles/los_source/mailminder/build/src/cvs/Root

26 2005-10-20 05:12:12 mailminder_{—}2004/dosformattedfiles/los_source/mailminder/build/src/cvs/Tag

2291 2005-10-2005:12:12 mailminder_{—}2004/dosformattedfiles/los_source/mailminder/build/src/Makefile

2306 2005-10-20 05:12:12 mailminder_{—}2004/dosformattedfiles/los_source/mailminder/build/src/Makefile.in

2254 2005-10-20 05:12:12 mailminder_{—}2004/dosformattedfiles/los_source/mailminder/build/src/mozMailminderModule.cp p

0 2005-10-20 05:12:12 mailminder_{—}2004/dosformattedfiles/los_source/mailminder/cvs/

428 2005-10-20 05:12:12 mailminder_{—}2004/dosformattedfiles/los_source/mailminder/cvs/Entries

32 2005-10-20 05:12:12 mailminder_{—}2004/dosformattedfiles/los_source/mailminder/cvs/Repository

43 2005-10-20 05:12:12 mailminder_{—}2004/dosformattedfiles/los_source/mailminder/cvs/Root

26 2005-10-20 05:12:12 mailminder_{—}2004/dosformattedfiles/los_source/mailminder/cvs/Tag

5739 2005-10-20 05:12:12 mailminder_{—}2004/dosformattedfiles/los_source/mailminder/jar.mn

2513 2005-10-20 05:12:12 mailminder_{—}2004/dosformattedfiles/los_source/mailminder/Makefile.in

0 2005-10-20 05:12:14 mailminder_{—}2004/dosformattedfiles/los_source/mailminder/misc/

441 2005-10-20 05:12:12 mailminder_{—}2004/dosformattedfiles/los_source/mailminder/misc/all.entries

0 2005-10-20 05:12:14 mailminder_{—}2004/dosformattedfiles/los_source/mailminder/misc/cvs/

157 2005-10-20 05:12:14 mailminder_{—}2004/dosformattedfiles/los_source/mailminder/misc/cvs/Entries

37 2005-10-20 05:12:14 mailminder_{—}2004/dosformattedfiles/los_source/mailminder/misc/cvs/Repository

43 2005-10-20 05:12:14 mailminder_{—}2004/dosformattedfiles/los_source/mailminder/misc/cvs/Root

26 2005-10-20 05:12:14 mailminder_{—}2004/dosformattedfiles/los_source/mailminder/misc/cvs/Tag

129 2005-10-20 05:12:14 mailminder_{—}2004/dosformattedfiles/los_source/mailminder/misc/installed-chrome.txt

1822 2005-10-20 05:12:14 mailminder_{—}2004/dosformattedfiles/los_source/mailminder/readme

0 2005-10-20 05:12:16 mailminder_{—}2004/dosformattedfiles/los_source/mailminder/resources/

0 2005-10-20 05:12:14 mailminder_{—}2004/dosformattedfiles/los_source/mailminder/resources/content/

3695 2005-10-20 05:12:14 mailminder_{—}2004/dosformattedfiles/los_source/mailminder/resources/content/configure.js

2574 2005-10-20 05:12:14 mailminder_{—}2004/dosformattedfiles/los_source/mailminder/resources/content/configure.xul

1023 2005-10-20 05:12:14 mailminder_{—}2004/dosformattedfiles/los_source/mailminder/resources/content/contents.rdf

1030 2005-10-20 05:12:14 mailminder_{—}2004/dosformattedfiles/los_source/mailminder/resources/content/contents.rdf.in

0 2005-10-20 05:12:14 mailminder_{—}2004/dosformattedfiles/los_source/mailminder/resources/content/cvs/

1877 2005-10-20 05:12:14 mailminder_{—}2004/dosformattedfiles/los_source/mailminder/resources/content/cvs/Entries

50 2005-10-20 05:12:14 mailminder_{—}2004/dosformattedfiles/los_source/mailminder/resources/content/cvs/Repository

43 2005-10-20 05:12:14 mailminder_{—}2004/dosformattedfiles/los_source/mailminder/resources/content/cvs/Root

26 2005-10-20 05:12:14 mailminder_{—}2004/dosformattedfiles/los_source/mailminder/resources/content/cvs/Tag

10474 2005-10-20 05:12:14 mailminder_{—}2004/dosformattedfiles/los_source/mailminder/resources/content/datepicker.xul

0 2005-10-20 05:12:14 mailminder_{—}2004/dosformattedfiles/los_source/mailminder/resources/content/html/

0 2005-10-20 05:12:14 mailminder_{—}2004/dosformattedfiles/los_source/mailminder/resources/content/html/cvs/

153 2005-10-20 05:12:14 mailminder_{—}2004/dosformattedfiles/los_source/mailminder/resources/content/html/cvs/Entries

55 2005-10-20 05:12:14 mailminder_{—}2004/dosformattedfiles/los_source/mailminder/resources/content/html/cvs/Repositor y

43 2005-10-20 05:12:14 mailminder_{—}2004/dosformattedfiles/los_source/mailminder/resources/content/html/cvs/Root

26 2005-10-20 05:12:14 mailminder_{—}2004/dosformattedfiles/los_source/mailminder/resources/content/html/cvs/Tag

420 2005-10-20 05:12:14 mailminder_{—}2004/dosformattedfiles/los_source/mailminder/resources/content/html/index.html

505 2005-10-20 05:12:14 mailminder_{—}2004/dosformattedfiles/los_source/mailminder/resources/content/html/previewError .html

9549 2005-10-20 05:12:14 mailminder_{—}2004/dosformattedfiles/los_source/mailminder/resources/content/insertAddresses.js

2658 2005-10-20 05:12:14 mailminder_{—}2004/dosformattedfiles/los_source/mailminder/resources/content/insertAddresses.xu l

3496 2005-10-20 05:12:14 mailminder_{—}2004/dosformattedfiles/los_source/mailminder/resources/content/loginDialog.js

1073 2005-10-2005:12:14 mailminder_{—}2004/dosformattedfiles/los_source/mailminder/resources/content/loginDialog.xul

5203 2005-10-2005:12:14 mailminder_{—}2004/dosformattedfiles/los_source/mailminder/resources/content/mailminder.js

2769 2005-10-20 05:12:14 mailminder_{—}2004/dosformattedfiles/los_source/mailminder/resources/content/mailminderOverla y.xul

11826 2005-10-20 05:12:14 mailminder_{—}2004/dosformattedfiles/los_source/mailminder/resources/content/mailminder-shared.js

6661 2005-10-20 05:12:14 mailminder_{—}2004/dosformattedfiles/los_source/mailminder/resources/content/pickers.xml

637 2005-10-20 05:12:14 mailminder_{—}2004/dosformattedfiles/los_source/mailminder/resources/content/progressDialog.js

968 2005-10-20 05:12:14 mailminder_{—}2004/dosformattedfiles/los_source/mailminder/resources/content/progressDialog.xul

26579 2005-10-20 05:12:14 mailminder_{—}2004/dosformattedfiles/los_source/mailminder/resources/content/winActivateDeacti vate.js

4508 2005-10-20 05:12:14 mailminder_{—}2004/dosformattedfiles/los_source/mailminder/resources/content/winActivateDeacti vate.xul

5415 2005-10-20 05:12:14 mailminder_{—}2004/dosformattedfiles/los_source/mailminder/resources/content/winInsert.js

2434 2005-10-20 05:12:14 mailminder_{—}2004/dosformattedfiles/los_source/mailminder/resources/content/winInsert.xul

4853 2005-10-20 05:12:14 mailminder_{—}2004/dosformattedfiles/los_source/mailminder/resources/content/winPreviewMsg.js

2218 2005-10-20 05:12:14 mailminder_{—}2004/dosformattedfiles/los_source/mailminder/resources/content/winPreviewMsg.x ul

23817 2005-10-20 05:12:14 mailminder_{—}2004/dosformattedfiles/los_source/mailminder/resources/content/winRetrieveRemo ve.js

11930 2005-10-20 05:12:14 mailminder_{—}2004/dosformattedfiles/los_source/mailminder/resources/content/winRetrieveRemo ve.xul

0 2005-10-20 05:12:14 mailminder_{—}2004/dosformattedfiles/los_source/mailminder/resources/cvs/

185 2005-10-20 05:12:14 mailminder_{—}2004/dosformattedfiles/los_source/mailminder/resources/cvs/Entries

42 2005-10-20 05:12:14 mailminder_{—}2004/dosformattedfiles/los_source/mailminder/resources/cvs/Repository

43 2005-10-20 05:12:14 mailminder_{—}2004/dosformattedfiles/los_source/mailminder/resources/cvs/Root

26 2005-10-20 05:12:14 mailminder_{—}2004/dosformattedfiles/los_source/mailminder/resources/cvs/Tag

0 2005-10-20 05:12:16 mailminder_{—}2004/dosformattedfiles/los_source/mailminder/resources/locale/

0 2005-10-20 05:12:14 mailminder_{—}2004/dosformattedfiles/los_source/mailminder/resources/locale/cvs/

14 2005-10-20 05:12:14 mailminder_{—}2004/dosformattedfiles/los_source/mailminder/resources/locale/cvs/Entries

49 2005-10-20 05:12:14 mailminder_{—}2004/dosformattedfiles/los_source/mailminder/resources/locale/cvs/Repository

43 2005-10-20 05:12:14 mailminder_{—}2004/dosformattedfiles/los_source/mailminder/resources/locale/cvs/Root

26 2005-10-20 05:12:14 mailminder_{—}2004/dosformattedfiles/los_source/mailminder/resources/locale/cvs/Tag

0 2005-10-20 05:12:16 mailminder_{—}2004/dosformattedfiles/los_source/mailminder/resources/locale/en-US/

1378 2005-10-20 05:12:16 mailminder_{—}2004/dosformattedfiles/los_source/mailminder/resources/locale/en-US/configure.dtd

1130 2005-10-20 05:12:16 mailminder_{—}2004/dosformattedfiles/los_source/mailminder/resources/locale/en-US/contents.rdf

0 2005-10-20 05:12:16 mailminder_{—}2004/dosformattedfiles/los_source/mailminder/resources/locale/en-US/cvs/

1043 2005-10-20 05:12:16 mailminder_{—}2004/dosformattedfiles/los_source/mailminder/resources/locale/en-US/cvs/Entries

55 2005-10-20 05:12:16 mailminder_{—}2004/dosformattedfiles/los_source/mailminder/resources/locale/en-US/cvs/Repository

43 2005-10-2005:12:16 mailminder_{—}2004/dosformattedfiles/los_source/mailminder/resources/locale/en-US/cvs/Root

26 2005-10-20 05:12:16 mailminder_{—}2004/dosformattedfiles/los_source/mailminder/resources/locale/en-US/cvs/Tag

867 2005-10-20 05:12:16 mailminder_{—}2004/dosformattedfiles/los_source/mailminder/resources/locale/en-US/datepicker.dtd

744 2005-10-20 05:12:16 mailminder_{—}2004/dosformattedfiles/los_source/mailminder/resources/locale/en-US/insertAddresses.dtd

294 2005-10-20 05:12:16 mailminder_{—}2004/dosformattedfiles/los_source/mailminder/resources/locale/en-US/loginDialog.dtd

474 2005-10-20 05:12:16 mailminder_{—}2004/dosformattedfiles/los_source/mailminder/resources/locale/en-US/mailminder.dtd

6113 2005-10-20 05:12:16 mailminder_{—}2004/dosformattedfiles/los_source/mailminder/resources/locale/en-US/mailminder.properties

51 2005-10-2005:12:16 mailminder_{—}2004/dosformattedfiles/los_source/mailminder/resources/locale/en-US/pickers.dtd

248 2005-10-20 05:12:16 mailminder_{—}2004/dosformattedfiles/los_source/mailminder/resources/locale/en-US/progressDialog.dtd

1494 2005-10-20 05:12:16 mailminder_{—}2004/dosformattedfiles/los_source/mailminder/resources/locale/en-US/winActivateDeactivate.dtd

559 2005-10-20 05:12:16 mailminder_{—}2004/dosformattedfiles/los_source/mailminder/resources/locale/en-US/winInsert.dtd

217 2005-10-20 05:12:16 mailminder_{—}2004/dosformattedfiles/los_source/mailminder/resources/locale/en-US/winPreviewMsg.dtd

1967 2005-10-20 05:12:16 mailminder_{—}2004/dosformattedfiles/los_source/mailminder/resources/locale/en-US/winRetrieveRemove.dtd

1809 2005-10-20 05:12:16 mailminder_{—}2004/dosformattedfiles/los_source/mailminder/resources/Makefile

1827 2005-10-20 05:12:16 mailminder_{—}2004/dosformattedfiles/los_source/mailminder/resources/Makefile.in

0 2005-10-20 05:12:16 mailminder_{—}2004/dosformattedfiles/los_source/mailminder/resources/skin/

554 2005-10-20 05:12:16 mailminder_{—}2004/dosformattedfiles/los_source/mailminder/resources/skin/contents.rdf

0 2005-10-20 05:12:16 mailminder_{—}2004/dosformattedfiles/los_source/mailminder/resources/skin/cvs/

260 2005-10-20 05:12:16 mailminder_{—}2004/dosformattedfiles/los_source/mailminder/resources/skin/cvs/Entries

47 2005-10-20 05:12:16 mailminder_{—}2004/dosformattedfiles/los_source/mailminder/resources/skin/cvs/Repository

43 2005-10-20 05:12:16 mailminder_{—}2004/dosformattedfiles/los_source/mailminder/resources/skin/cvs/Root

26 2005-10-20 05:12:16 mailminder_{—}2004/dosformattedfiles/los_source/mailminder/resources/skin/cvs/Tag

2451 2005-10-2005:12:16 mailminder_{—}2004/dosformattedfiles/los_source/mailminder/resources/skin/datepicker.css

0 2005-10-20 05:12:16 mailminder_{—}2004/dosformattedfiles/los_source/mailminder/resources/skin/icons/

0 2005-10-20 05:12:16 mailminder_{—}2004/dosformattedfiles/los_source/mailminder/resources/skin/icons/cvs/

410 2005-10-20 05:12:16 mailminder_{—}2004/dosformattedfiles/los_source/mailminder/resources/skin/icons/cvs/Entries

53 2005-10-20 05:12:16 mailminder_{—}2004/dosformattedfiles/los_source/mailminder/resources/skin/icons/cvs/Repository

43 2005-10-2005:12:16 mailminder_{—}2004/dosformattedfiles/los_source/mailminder/resources/skin/icons/cvs/Root

26 2005-10-20 05:12:16 mailminder_{—}2004/dosformattedfiles/los_source/mailminder/resources/skin/icons/cvs/Tag

0 2005-10-20 05:12:16 mailminder_{—}2004/dosformattedfiles/los_source/mailminder/resources/skin/images/

0 2005-10-20 05:12:16 mailminder_{—}2004/dosformattedfiles/los_source/mailminder/resources/skin/images/cvs/

2501 2005-10-2005:12:16 mailminder_{—}2004/dosformattedfiles/los_source/mailminder/resources/skin/images/cvs/Entries

54 2005-10-20 05:12:16 mailminder_{—}2004/dosformattedfiles/los_source/mailminder/resources/skin/images/cvs/Repositor y

43 2005-10-20 05:12:16 mailminder_{—}2004/dosformattedfiles/los_source/mailminder/resources/skin/images/cvs/Root

26 2005-10-20 05:12:16 mailminder_{—}2004/dosformattedfiles/los_source/mailminder/resources/skin/images/cvs/Tag

2834 2005-10-20 05:12:16 mailminder_{—}2004/dosformattedfiles/los_source/mailminder/resources/skin/mailminder.css

0 2005-10-20 05:12:18 mailminder_{—}2004/dosformattedfiles/los_source/mailminder/scripts/

462 2005-10-20 05:12:16 mailminder_{—}2004/dosformattedfiles/los_source/mailminder/scripts/build_hooks.sh

596 2005-10-20 05:12:16 mailminder_{—}2004/dosformattedfiles/los_source/mailminder/scripts/build_xpi.sh

0 2005-10-20 05:12:16 mailminder_{—}2004/dosformattedfiles/los_source/mailminder/scripts/cvs/

599 2005-10-20 05:12:16 mailminder_{—}2004/dosformattedfiles/los_source/mailminder/scripts/cvs/Entries

40 2005-10-20 05:12:16 mailminder_{—}2004/dosformattedfiles/los_source/mailminder/scripts/cvs/Repository

43 2005-10-20 05:12:16 mailminder_{—}2004/dosformattedfiles/los_source/mailminder/scripts/cvs/Root

26 2005-10-20 05:12:16 mailminder_{—}2004/dosformattedfiles/los_source/mailminder/scripts/cvs/Tag

4327 2005-10-20 05:12:16 mailminder_{—}2004/dosformattedfiles/los_source/mailminder/scripts/install.js.in

233 2005-10-20 05:12:16 mailminder_{—}2004/dosformattedfiles/los_source/mailminder/scripts/mailminder.js

101 2005-10-20 05:12:18 mailminder_{—}2004/dosformattedfiles/los_source/mailminder/scripts/move_xpi.sh

1158 2005-10-20 05:12:18 mailminder_{—}2004/dosformattedfiles/los_source/mailminder/scripts/project_init.sh

947 2005-10-20 05:12:18 mailminder_{—}2004/dosformattedfiles/los_source/mailminder/scripts/version

7 2005-10-20 05:12:18 mailminder_{—}2004/dosformattedfiles/los_source/mailminder/version

0 2005-10-20 05:12:18 mailminder_{—}2004/dosformattedfiles/mailminder/

0 2005-10-20 05:12:18 mailminder_{—}2004/dosformattedfiles/mailminder/php_mm/

801 2005-10-20 05:12:18 mailminder_{—}2004/dosformattedfiles/mailminder/php_mm/authentication.php

814 2005-10-20 05:12:18 mailminder_{—}2004/dosformattedfiles/mailminder/php_mm/buy_service_response.php

77 2005-10-20 05:12:18 mailminder_{—}2004/dosformattedfiles/mailminder/php_mm/cron_mm lindows.txt

60 2005-10-20 05:12:18 mailminder_{—}2004/dosformattedfiles/mailminder/php_mm/cron_mm_sti.txt

0 2005-10-20 05:12:18 mailminder_{—}2004/dosformattedfiles/mailminder/php_mm/cvs/

846 2005-10-20 05:12:18 mailminder_{—}2004/dosformattedfiles/mailminder/php_mm/cvs/Entries

35 2005-10-20 05:12:18 mailminder_{—}2004/dosformattedfiles/mailminder/php_mm/cvs/Repository

26 2005-10-20 05:12:18 mailminder_{—}2004/dosformattedfiles/mailminder/php_mm/cvs/Root

6339 2005-10-20 05:12:18 mailminder_{—}2004/dosformattedfiles/mailminder/php_mm/findmsg.php

541 2005-10-20 05:12:18 mailminder_{—}2004/dosformattedfiles/mailminder/php_mm/log_in_response.php

0 2005-10-20 05:12:18 mailminder_{—}2004/dosformattedfiles/mailminder/php_mm/Mail/

0 2005-10-20 05:12:18 mailminder_{—}2004/dosformattedfiles/mailminder/php_mm/Mail/cvs/

408 2005-10-20 05:12:18 mailminder_{—}2004/dosformattedfiles/mailminder/php_mm/Mail/cvs/Entries

40 2005-10-20 05:12:18 mailminder_{—}2004/dosformattedfiles/mailminder/php_mm/Mail/cvs/Repository

26 2005-10-20 05:12:18 mailminder_{—}2004/dosformattedfiles/mailminder/php_mm/Mail/cvs/Root

7654 2005-10-20 05:12:18 mailminder_{—}2004/dosformattedfiles/mailminder/php_mm/Mail/Mail.php

7665 2005-10-20 05:12:18 mailminder_{—}2004/dosformattedfiles/mailminder/php_mm/Mail/MailMinder.inc

7840 2005-10-20 05:12:18 mailminder_{—}2004/dosformattedfiles/mailminder/php_mm/Mail/MailMinderTEST.inc

24387 2005-10-20 05:12:18 mailminder_{—}2004/dosformattedfiles/mailminder/php_mm/Mail/mime.php

34499 2005-10-20 05:12:18 mailminder_{—}2004/dosformattedfiles/mailminder/php_mm/Mail/mimeDecode.php

13264 2005-10-20 05:12:18 mailminder_{—}2004/dosformattedfiles/mailminder/php_mm/Mail/mimePart.php

29487 2005-10-20 05:12:18 mailminder_{—}2004/dosformattedfiles/mailminder/php_mm/Mail/PEAR.php

32289 2005-10-20 05:12:18 mailminder_{—}2004/dosformattedfiles/mailminder/php_mm/Mail/RFC822.php

3112 2005-10-20 05:12:18 mailminder_{—}2004/dosformattedfiles/mailminder/php_mm/Mail/SendMail.php

8690 2005-10-20 05:12:18 mailminder_{—}2004/dosformattedfiles/mailminder/php_mm/Mail/smtpMail.php

3318 2005-10-20 05:12:18 mailminder_{—}2004/dosformattedfiles/mailminder/php_mm/mailCheck.php

1250 2005-10-20 05:12:18 mailminder_{—}2004/dosformattedfiles/mailminder/php_mm/MailMinder.sql

626 2005-10-20 05:12:18 mailminder_{—}2004/dosformattedfiles/mailminder/php_mm/mm_login.php

5983 2005-10-20 05:12:18 mailminder_{—}2004/dosformattedfiles/mailminder/php_mm/previewmsg.php

793 2005-10-20 05:12:18 mailminder_{—}2004/dosformattedfiles/mailminder/php_mm/removemsg.php

2733 2005-10-20 05:12:18 mailminder_{—}2004/dosformattedfiles/mailminder/php_mm/retmsg.php

3141 2005-10-2005:12:18 mailminder_{—}2004/dosformattedfiles/mailminder/php_mm/sendnowrequest.php

3189 2005-10-20 05:12:18 mailminder_{—}2004/dosformattedfiles/mailminder/php_mm/sendnowrequest_test.php

2253 2005-10-20 05:12:18 mailminder_{—}2004/dosformattedfiles/mailminder/php_mm/textgetmail.php

6403 2005-10-20 05:12:18 mailminder_{—}2004/dosformattedfiles/mailminder/php_mm/xmlMailpro.php

0 2005-10-20 05:12:18 mailminder_{—}2005/

0 2005-10-20 05:12:18 mailminder_{—}2005/code/

5738 2005-10-20 05:12:18 mailminder_{—}2005/code/jar.mn

0 2005-10-20 05:12:18 mailminder_{—}2005/code/misc/

440 2005-10-20 05:12:18 mailminder_{—}2005/code/misc/all.entries

128 2005-10-20 05:12:18 mailminder_{—}2005/code/misc/installed-chrome.txt

0 2005-10-20 05:12:22 mailminder_{—}2005/code/resources/

0 2005-10-20 05:12:20 mailminder_{—}2005/code/resources/skin/

553 2005-10-20 05:12:18 mailminder_{—}2005/code/resources/skin/contents.rdf

2450 2005-10-20 05:12:18 mailminder_{—}2005/code/resources/skin/datepicker.css

3316 2005-10-20 05:12:18 mailminder_{—}2005/code/resources/skin/mailminder.css

0 2005-10-20 05:12:20 mailminder_{—}2005/code/resources/skin/images/

1021 2005-10-20 05:12:18 mailminder_{—}2005/code/resources/skin/images/calendar.gif

215 2005-10-20 05:12:18 mailminder_{—}2005/code/resources/skin/images/da.png

187 2005-10-20 05:12:20 mailminder_{—}2005/code/resources/skin/images/la.png

198 2005-10-20 05:12:20 mailminder_{—}2005/code/resources/skin/images/lda.png

674 2005-10-20 05:12:20 mailminder_{—}2005/code/resources/skin/images/mm-calmback-disabled.png

839 2005-10-20 05:12:20 mailminder_{—}2005/code/resources/skin/images/mm-calmback-hover.png

816 2005-10-20 05:12:20 mailminder_{—}2005/code/resources/skin/images/mm-calmback.png

692 2005-10-20 05:12:20 mailminder_{—}2005/code/resources/skin/images/mm-calmfwd-disabled.png

859 2005-10-20 05:12:20 mailminder_{—}2005/code/resources/skin/images/mm-calmfwd-hover.png

830 2005-10-20 05:12:20 mailminder_{—}2005/code/resources/skin/images/mm-calmfwd.png

743 2005-10-20 05:12:20 mailminder_{—}2005/code/resources/skin/images/mm-caltoday-hover.png

696 2005-10-20 05:12:20 mailminder_{—}2005/code/resources/skin/images/mm-caltoday.png

596 2005-10-20 05:12:20 mailminder_{—}2005/code/resources/skin/images/mm-calyback-disabled.png

648 2005-10-20 05:12:20 mailminder_{—}2005/code/resources/skin/images/mm-calyback-hover.png

637 2005-10-20 05:12:20 mailminder_{—}2005/code/resources/skin/images/mm-calyback.png

586 2005-10-20 05:12:20 mailminder_{—}2005/code/resources/skin/images/mm-calyfwd-disabled.png

668 2005-10-20 05:12:20 mailminder_{—}2005/code/resources/skin/images/mm-calyfwd-hover.png

664 2005-10-20 05:12:20 mailminder_{—}2005/code/resources/skin/images/mm-calyfwd.png

323 2005-10-20 05:12:20 mailminder_{—}2005/code/resources/skin/images/mm-downarrow-disabled.png

347 2005-10-20 05:12:20 mailminder_{—}2005/code/resources/skin/images/mm-downarrow-hover.png

340 2005-10-20 05:12:20 mailminder_{—}2005/code/resources/skin/images/mm-downarrow.png

477 2005-10-20 05:12:20 mailminder_{—}2005/code/resources/skin/images/mm-hidoptions-hover.png

475 2005-10-20 05:12:20 mailminder_{—}2005/code/resources/skin/images/mm-hidoptions.png

461 2005-10-20 05:12:20 mailminder_{—}2005/code/resources/skin/images/mm-showoptions-hover.png

466 2005-10-20 05:12:20 mailminder_{—}2005/code/resources/skin/images/mm-showoptions.png

327 2005-10-20 05:12:20 mailminder_{—}2005/code/resources/skin/images/mm-uparrow-disabled.png

341 2005-10-20 05:12:20 mailminder_{—}2005/code/resources/skin/images/mm-uparrow-hover.png

332 2005-10-20 05:12:20 mailminder_{—}2005/code/resources/skin/images/mm-uparrow.png

186 2005-10-20 05:12:20 mailminder_{—}2005/code/resources/skin/images/ra.png

200 2005-10-20 05:12:20 mailminder_{—}2005/code/resources/skin/images/rda.png

204 2005-10-20 05:12:20 mailminder_{—}2005/code/resources/skin/images/ua.png

0 2005-10-20 05:12:20 mailminder_{—}2005/code/resources/skin/icons/

12537 2005-10-20 05:12:20 mailminder_{—}2005/code/resources/skin/icons/mailminder-128.png

505 2005-10-20 05:12:20 mailminder_{—}2005/code/resources/skin/icons/mailminder-16.png

3962 2005-10-20 05:12:20 mailminder_{—}2005/code/resources/skin/icons/mailminder-22.png

3332 2005-10-20 05:12:20 mailminder_{—}2005/code/resources/skin/icons/mailminder-48.png

4930 2005-10-20 05:12:20 mailminder_{—}2005/code/resources/skin/icons/mailminder-64.png

0 2005-10-20 05:12:20 mailminder_{—}2005/code/resources/locale/

0 2005-10-20 05:12:20 mailminder_{—}2005/code/resources/locale/en-US/

1377 2005-10-20 05:12:20 mailminder_{—}2005/code/resources/locale/en-US/configure.dtd

1129 2005-10-20 05:12:20 mailminder_{—}2005/code/resources/locale/en-US/contents.rdf

866 2005-10-20 05:12:20 mailminder_{—}2005/code/resources/locale/en-US/datepicker.dtd

743 2005-10-20 05:12:20 mailminder_{—}2005/code/resources/locale/en US/insertAddresses.dtd

293 2005-10-20 05:12:20 mailminder_{—}2005/code/resources/locale/en-US/loginDialog.dtd

473 2005-10-20 05:12:20 mailminder_{—}2005/code/resources/locale/en-US/mailminder.dtd

6645 2005-10-20 05:12:20 mailminder_{—}2005/code/resources/locale/en-US/mailminder.properties

50 2005-10-20 05:12:20 mailminder_{—}2005/code/resources/locale/en-US/pickers.dtd

247 2005-10-20 05:12:20 mailminder_{—}2005/code/resources/locale/en-US/progressDialog.dtd

1916 2005-10-20 05:12:20 mailminder_{—}2005/code/resources/locale/en-US/winActivateDeactivate.dtd

558 2005-10-20 05:12:20 mailminder_{—}2005/code/resources/locale/en-US/winInsert.dtd

216 2005-10-20 05:12:20 mailminder_{—}2005/code/resources/locale/en-US/winPreviewMsg.dtd

1966 2005-10-20 05:12:20 mailminder_{—}2005/code/resources/locale/en-US/winRetrieveRemove.dtd

0 2005-10-20 05:12:22 mailminder_{—}2005/code/resources/content/

3694 2005-10-20 05:12:22 mailminder_{—}2005/code/resources/content/configure.js

2573 2005-10-20 05:12:22 mailminder_{—}2005/code/resources/content/configure.xul

1022 2005-10-20 05:12:22 mailminder_{—}2005/code/resources/content/contents.rdf

1029 2005-10-20 05:12:22 mailminder_{—}2005/code/resources/content/contents.rdf.in

10473 2005-10-20 05:12:22 mailminder_{—}2005/code/resources/content/datepicker.xul

9605 2005-10-20 05:12:22 mailminder_{—}2005/code/resources/content/insertAddresses.js

2657 2005-10-20 05:12:22 mailminder_{—}2005/code/resources/content/insertAddresses.xul

3574 2005-10-20 05:12:22 mailminder_{—}2005/code/resources/content/loginDialog.js

1179 2005-10-20 05:12:22 mailminder_{—}2005/code/resources/content/loginDialog.xul

13382 2005-10-20 05:12:22 mailminder_{—}2005/code/resources/content/mailminder-shared.js

6400 2005-10-20 05:12:22 mailminder_{—}2005/code/resources/content/mailminder.js

2768 2005-10-20 05:12:22 mailminder_{—}2005/code/resources/content/mailminderOverlay.xul

6660 2005-10-20 05:12:22 mailminder_{—}2005/code/resources/content/pickers.xml

636 2005-10-20 05:12:22 mailminder_{—}2005/code/resources/content/progressDialog.js

937 2005-10-20 05:12:22 mailminder_{—}2005/code/resources/content/progressDialog.xul

30235 2005-10-20 05:12:22 mailminder_{—}2005/code/resources/content/winActivateDeactivate.js

6334 2005-10-20 05:12:22 mailminder_{—}2005/code/resources/content/winActivateDeactivate.xul

5414 2005-10-20 05:12:22 mailminder_{—}2005/code/resources/content/winInsert.js

2433 2005-10-20 05:12:22 mailminder_{—}2005/code/resources/content/winInsert.xul

4852 2005-10-20 05:12:22 mailminder_{—}2005/code/resources/content/winPreviewMsg.js

2217 2005-10-20 05:12:22 mailminder_{—}2005/code/resources/content/winPreviewMsg.xul

23589 2005-10-20 05:12:22 mailminder_{—}2005/code/resources/content/winRetrieveRemove.js

11929 2005-10-20 05:12:22 mailminder_{—}2005/code/resources/content/winRetrieveRemove.xul

0 2005-10-20 05:12:22 mailminder_{—}2005/code/resources/content/html/

419 2005-10-20 05:12:22 mailminder_{—}2005/code/resources/content/html/index.html

504 2005-10-20 05:12:22 mailminder_{—}2005/code/resources/content/html/previewError.html

0 2005-10-20 05:40:56 mailminder_{—}2005/dosformattedfiles/

0 2005-10-20 05:41:12 mailminder_{—}2005/dosformattedfiles/misc/

126 2005-10-20 05:43:34 mailminder_{—}2005/dosformattedfiles/misc/installed-chrome.txt

438 2005-10-20 05:43:18 mailminder_{—}2005/dosformattedfiles/misc/all.entries

0 2005-10-20 05:41:12 mailminder_{—}2005/dosformattedfiles/resources/

0 2005-10-20 05:41:12 mailminder_{—}2005/dosformattedfiles/resources/content/

3692 2005-10-20 05:44:04 mailminder_{—}2005/dosformattedfiles/resources/content/configure.js

2571 2005-10-20 05:44:18 mailminder_{—}2005/dosformattedfiles/resources/content/configure.xul

10471 2005-10-20 05:45:04 mailminder_{—}2005/dosformattedfiles/resources/content/datepicker.xul

9603 2005-10-20 05:45:16 mailminder_{—}2005/dosformattedfiles/resources/content/insertAddresses.js

2655 2005-10-20 05:45:30 mailminder_{—}2005/dosformattedfiles/resources/content/insertAddresses.xul

3572 2005-10-20 05:45:52 mailminder_{—}2005/dosformattedfiles/resources/content/loginDialog.js

1177 2005-10-20 05:46:02 mailminder_{—}2005/dosformattedfiles/resources/content/loginDialog.xul

13380 2005-10-20 05:46:28 mailminder_{—}2005/dosformattedfiles/resources/content/mailminder-shared.js

6398 2005-10-20 05:46:10 mailminder_{—}2005/dosformattedfiles/resources/content/mailminder.js

2766 2005-10-20 05:46:20 mailminder_{—}2005/dosformattedfiles/resources/content/mailminderOverlay.xul

6658 2005-10-20 05:46:36 mailminder_{—}2005/dosformattedfiles/resources/content/pickers.xml

634 2005-10-20 05:46:44 mailminder_{—}2005/dosformattedfiles/resources/content/progressDialog.js

935 2005-10-20 05:46:58 mailminder_{—}2005/dosformattedfiles/resources/content/progressDialog.xul

30234 2005-10-20 05:47:06 mailminder_{—}2005/dosformattedfiles/resources/content/winActivateDeactivate.js

6332 2005-10-20 05:47:14 mailminder_{—}2005/dosformattedfiles/resources/content/winActivateDeactivate.xul

5412 2005-10-20 05:47:22 mailminder_{—}2005/dosformattedfiles/resources/content/winInsert.js

2431 2005-10-20 05:47:30 mailminder_{—}2005/dosformattedfiles/resources/content/winInsert.xul

4850 2005-10-20 05:47:38 mailminder_{—}2005/dosformattedfiles/resources/content/winPreviewMsg.js

2215 2005-10-20 05:47:46 mailminder_{—}2005/dosformattedfiles/resources/content/winPreviewMsg.xul

23587 2005-10-20 05:47:54 mailminder_{—}2005/dosformattedfiles/resources/content/winRetrieveRemove.js

11927 2005-10-20 05:48:14 mailminder_{—}2005/dosformattedfiles/resources/content/winRetrieveRemove.xul

0 2005-10-20 05:41:12 mailminder_{—}2005/dosformattedfiles/resources/content/html/

419 2005-10-20 05:12:22 mailminder_{—}2005/dosformattedfiles/resources/content/html/index.html

504 2005-10-20 05:12:22 mailminder_{—}2005/dosformattedfiles/resources/content/html/previewError.html

1027 2005-10-20 05:44:54 mailminder_{—}2005/dosformattedfiles/resources/content/contents.rdf.in

1020 2005-10-20 05:44:38 mailminder_{—}2005/dosformattedfiles/resources/content/contents.rdf

0 2005-10-20 05:41:12 mailminder_{—}2005/dosformattedfiles/resources/locale/

0 2005-10-20 05:41:12 mailminder_{—}2005/dosformattedfiles/resources/locale/en-US/

1377 2005-10-20 05:12:20 mailminder_{—}2005/dosformattedfiles/resources/locale/en-US/configure.dtd

1129 2005-10-20 05:12:20 mailminder_{—}2005/dosformattedfiles/resources/locale/en-US/contents.rdf

866 2005-10-20 05:12:20 mailminder_{—}2005/dosformattedfiles/resources/locale/en-US/datepicker.dtd

743 2005-10-20 05:12:20 mailminder_{—}2005/dosformattedfiles/resources/locale/en-US/insertAddresses.dtd

293 2005-10-20 05:12:20 mailminder_{—}2005/dosformattedfiles/resources/locale/en-US/loginDialog.dtd

473 2005-10-20 05:12:20 mailminder_{—}2005/dosformattedfiles/resources/locale/en-US/mailminder.dtd

6645 2005-10-20 05:12:20 mailminder_{—}2005/dosformattedfiles/resources/locale/en-US/mailminder.properties

50 2005-10-20 05:12:20 mailminder_{—}2005/dosformattedfiles/resources/locale/en-US/pickers.dtd

247 2005-10-20 05:12:20 mailminder_{—}2005/dosformattedfiles/resources/locale/en-US/progressDialog.dtd

1916 2005-10-20 05:12:20 mailminder_{—}2005/dosformattedfiles/resources/locale/en-US/winActivateDeactivate.dtd

558 2005-10-20 05:12:20 mailminder_{—}2005/dosformattedfiles/resources/locale/en-US/winInsert.dtd

216 2005-10-20 05:12:20 mailminder_{—}2005/dosformattedfiles/resources/locale/en-US/winPreviewMsg.dtd

1966 2005-10-20 05:12:20 mailminder_{—}2005/dosformattedfiles/resources/locale/en-US/winRetrieveRemove.dtd

0 2005-10-20 05:41:12 mailminder_{—}2005/dosformattedfiles/resources/skin/

553 2005-10-20 05:12:18 mailminder_{—}2005/dosformattedfiles/resources/skin/contents.rdf

2450 2005-10-20 05:12:18 mailminder_{—}2005/dosformattedfiles/resources/skin/datepicker.css

3316 2005-10-20 05:12:18 mailminder_{—}2005/dosformattedfiles/resources/skin/mailminder.css

0 2005-10-20 05:41:12 mailminder_{—}2005/dosformattedfiles/resources/skin/icons/

12537 2005-10-20 05:12:20 mailminder_{—}2005/dosformattedfiles/resources/skin/icons/mailminder-128.png

505 2005-10-20 05:12:20 mailminder_{—}2005/dosformattedfiles/resources/skin/icons/mailminder-16.png

3962 2005-10-20 05:12:20 mailminder_{—}2005/dosformattedfiles/resources/skin/icons/mailminder-22.png

3332 2005-10-20 05:12:20 mailminder_{—}2005/dosformattedfiles/resources/skin/icons/mailminder-48.png

4930 2005-10-20 05:12:20 mailminder_{—}2005/dosformattedfiles/resources/skin/icons/mailminder-64.png

0 2005-10-20 05:41:12 mailminder_{—}2005/dosformattedfiles/resources/skin/images/

1021 2005-10-20 05:12:18 mailminder_{—}2005/dosformattedfiles/resources/skin/images/calendar.gif

215 2005-10-20 05:12:18 mailminder_{—}2005/dosformattedfiles/resources/skin/images/da.png

187 2005-10-20 05:12:20 mailminder_{—}2005/dosformattedfiles/resources/skin/images/la.png

198 2005-10-20 05:12:20 mailminder_{—}2005/dosformattedfiles/resources/skin/images/lda.png

674 2005-10-20 05:12:20 mailminder_{—}2005/dosformattedfiles/resources/skin/images/mm-calmback-disabled.png

839 2005-10-20 05:12:20 mailminder_{—}2005/dosformattedfiles/resources/skin/images/mm-calmback-hover.png

816 2005-10-20 05:12:20 mailminder_{—}2005/dosformattedfiles/resources/skin/images/mm-calmback.png

692 2005-10-20 05:12:20 mailminder_{—}2005/dosformattedfiles/resources/skin/images/mm-calmfwd-disabled.png

859 2005-10-20 05:12:20 mailminder_{—}2005/dosformattedfiles/resources/skin/images/mm-calmfwd-hover.png

830 2005-10-20 05:12:20 mailminder_{—}2005/dosformattedfiles/resources/skin/images/mm-calmfwd.png

743 2005-10-20 05:12:20 mailminder_{—}2005/dosformattedfiles/resources/skin/images/mm-caltoday-hover.png

696 2005-10-20 05:12:20 mailminder_{—}2005/dosformattedfiles/resources/skin/images/mm-caltoday.png

596 2005-10-20 05:12:20 mailminder_{—}2005/dosformattedfiles/resources/skin/images/mm-calyback-disabled.png

648 2005-10-20 05:12:20 mailminder_{—}2005/dosformattedfiles/resources/skin/images/mm-calyback-hover.png

637 2005-10-20 05:12:20 mailminder_{—}2005/dosformattedfiles/resources/skin/images/mm-calyback.png

586 2005-10-20 05:12:20 mailminder_{—}2005/dosformattedfiles/resources/skin/images/mm-calyfwd-disabled.png

668 2005-10-20 05:12:20 mailminder_{—}2005/dosformattedfiles/resources/skin/images/mm-calyfwd-hover.png

664 2005-10-20 05:12:20 mailminder_{—}2005/dosformattedfiles/resources/skin/images/mm-calyfwd.png

323 2005-10-20 05:12:20 mailminder_{—}2005/dosformattedfiles/resources/skin/images/mm-downarrow-disabled.png

347 2005-10-20 05:12:20 mailminder_{—}2005/dosformattedfiles/resources/skin/images/mm-downarrow-hover.png

340 2005-10-20 05:12:20 mailminder_{—}2005/dosformattedfiles/resources/skin/images/mm-downarrow.png

477 2005-10-20 05:12:20 mailminder_{—}2005/dosformattedfiles/resources/skin/images/mm-hidoptions-hover.png

475 2005-10-20 05:12:20 mailminder_{—}2005/dosformattedfiles/resources/skin/images/mm-hidoptions.png

461 2005-10-20 05:12:20 mailminder_{—}2005/dosformattedfiles/resources/skin/images/mm-showoptions-hover.png

466 2005-10-20 05:12:20 mailminder_{—}2005/dosformattedfiles/resources/skin/images/mm-showoptions.png

327 2005-10-20 05:12:20 mailminder_{—}2005/dosformattedfiles/resources/skin/images/mm-uparrow-disabled.png

341 2005-10-20 05:12:20 mailminder_{—}2005/dosformattedfiles/resources/skin/images/mm-uparrow-hover.png

332 2005-10-20 05:12:20 mailminder_{—}2005/dosformattedfiles/resources/skin/images/mm-uparrow.png

186 2005-10-20 05:12:20 mailminder_{—}2005/dosformattedfiles/resources/skin/images/ra.png

200 2005-10-20 05:12:20 mailminder_{—}2005/dosformattedfiles/resources/skin/images/rda.png

204 2005-10-20 05:12:20 mailminder_{—}2005/dosformattedfiles/resources/skin/images/ua.png

5736 2005-10-20 05:42:34 mailminder_{—}2005/dosformattedfiles/jar.mn

What is claimed:

1. A method of transferring originally sent email messages to a remote server for forwarding at a later time to a specified list of recipients, said method comprising the steps of:
providing a network interface over said network facilities connectable to email servers and to said remote server;
connecting to an email server;
retrieving and displaying messages from the email server;
permitting a user selection of retrieved email messages;
accepting a command from a user to forward email messages to the remote server;
providing a display wherein a time of delivery and a list of recipient addresses may be specified;
connecting to the remote server; and
sending to the remote server the user-selected email messages to the remote server, each message being provided with a time of delivery and a list of recipient addresses as specified by a user.

2. A method according to claim 1, further comprising the steps of:
sending a request to the remote server to retrieve a list of pending messages; and
receive a list of pending messages.

3. A method according to claim 1, further comprising the steps of:
submitting a search request to the remote server, the search request including or referencing a search query; and
receiving a list of pending messages in connection with a search request.

4. A method according to claim 1, further comprising the steps of:
submitting a request to remove a pending message to the remote server, the removal request identifying at least one pending message.

5. A method according to claim 1, further comprising the step of transmitting an authentication or identification token to the remote server.

6. A method according to claim 5, wherein the token is contained in an HTTP cookie and the function of transmitting the token is performed through the HTTP protocol.

7. A method according to claim 1, further comprising the steps of:
presenting to a user an object to enter a default time for forwarded messages;
receiving from a user a default time through the presented object; and
assigning a default time to a message to be forwarded to the remote server.

8. A method according to claim 1, further comprising the steps of:
presenting to a user an object to enter a default list of recipient addresses;
receiving from a user entry of recipient addresses through the presented object; and
including in the handling details of a forwarded email message to the remote server the default list of recipient addresses.

9. A method according to claim 8, further comprising the steps of:
presenting to a user an object for the selection of a time interval;
receiving from a user a selection of a time interval;
calculating a time of delivery from a present time and a selected time interval;
assigning the calculated time of delivery to a forwarded email message sent to the remote server.

10. An email client system for controlling the transferring of originally sent email messages to a remote server for later forwarding at a later time to a list of recipients, comprising:
a processor;
storage accessible by said processor;
network facilities operable by said processor to communicate with the remote server and email servers over a network;
computer readable instructions stored on said storage, said instructions executable by said processor to achieve the functions of:
providing a network interface over said network facilities connectable to email servers and to said remote server;
connecting to an email server;
retrieving and displaying messages from the email server;
permitting a user selection of retrieved email messages;
accepting a command from a user to forward email messages to the remote server;
providing a display wherein a time of delivery and a list of recipient addresses may be specified;
connecting to the remote server; and
sending to the remote server the user-selected email messages to the remote server, each message being provided with a time of delivery and a list of recipient addresses as specified by a user.

11. An email client system according to claim 10, wherein said computer readable instructions are further executable to achieve the functions of:
sending a request to the remote server to retrieve a list of pending messages;
receive a list of pending messages;
submitting a search request to the remote server, the search request including or referencing a search query;
receiving a list of pending messages in connection with a search request; and
submitting a request to remove a pending message to the remote server, the removal request identifying at least one pending message.

12. An email client system according to claim 10, wherein said computer readable instructions are further executable to achieve the functions of:
presenting to a user an object to enter a default time for forwarded messages;
receiving from a user a default time through the presented object; and
assigning a default time to a message to be forwarded to the remote server.

13. An email client system according to claim 10, wherein said computer readable instructions are further executable to achieve the functions of:
presenting to a user an object to enter a default list of recipient addresses;
receiving from a user entry of recipient addresses through the presented object; and
including in the handling details of a forwarded email message to the remote server the default list of recipient addresses.

14. An email client system according to claim 10, wherein said computer readable instructions are further executable to achieve the functions of:
presenting to a user an object for the selection of a time interval;
receiving from a user a selection of a time interval;
calculating a time of delivery from a present time and a selected time interval;
assigning the calculated time of delivery to a forwarded email message sent to the remote server.

15. A method of transferring data across a network between a Mailminder service, email clients and email servers, comprising the steps of:
Carrying a request to connect from an email client to a Mailminder service;
Transferring a user identity or token to the Mailminder service;
Transferring from an email client an email message to the Mailminder service;
Transferring from an email client handling details of the email message including the time of delivery of the email message and a list of recipient addresses; and
At the time controlled by the time of delivery of the handling details of an email message, transferring the email message from the Mailminder service to the email servers corresponding to the list of recipient addresses of the handling details of the transferred email message.

16. A method according to claim 15, further comprising the step of carrying authentication traffic between an email client and a Mailminder service.

17. A method according to claim 16, wherein the authentication traffic includes a token from an HTTP cookie stored at the email client.

18. A method according to claim 15, further comprising the steps of:
Transferring from an email client to the Mailminder service a request to retrieve pending messages; and
Transferring from the Mailminder to the requesting email client the requested pending email messages.

19. A method according to claim 15, further comprising the steps of:
Transferring from an email client to the Mailminder service a request for a list of pending messages;
Transferring from the Mailminder service to the requesting email client a list of pending messages.

20. A method according to claim 15, further comprising the steps of:
Transferring from an email client to the Mailminder service a search query for a search to be performed against pending email messages;
Transferring from the Mailminder service to the querying email client identification of pending email messages matching the search query.

21. A method according to claim 15, further comprising the steps of:
Transferring from an email client to the Mailminder service a request to remove pending email messages.

22. A method according to claim 15, wherein the email messages transferred from the Mailminder service to the email servers specified in the corresponding handling details includes a header of origination identifying the Mailminder service.
